(19) United States
(12) Patent Application Publication
(10) Pub. No.: US 2026/0135592 A1
(43) Pub. Date: May 14, 2026

(54) HYBRID BEAMFORMING DESIGN METHOD AND HYBRID BEAMFORMING DESIGN DEVICE

(71) Applicants: Samsung Electronics Co., Ltd., Suwon-si (KR); KOREA ADVANCED INSTITUTE OF SCIENCE AND TECHNOLOGY, Daejeon (KR)

(72) Inventors: Joosung PARK, Suwon-si (KR); Hyuncheol PARK, Daejeon (KR); Hyunsoo SON, Daejeon (KR)

(21) Appl. No.: 19/445,243

(22) Filed: Jan. 9, 2026

Related U.S. Application Data
(63) Continuation of application No. PCT/KR2024/005147, filed on Apr. 17, 2024.

(30) Foreign Application Priority Data
Jul. 10, 2023 (KR) 10-2023-0089435
Aug. 8, 2023 (KR) 10-2023-0103465

(51) Int. Cl. H04B 7/0456

(52) U.S. Cl. CPC H04B 7/0456

(57) ABSTRACT

A hybrid beamforming design method may include: designing initial radio frequency beamforming; designing baseband beamforming; and calculating a performance index; calculating a first performance index based on first radio frequency beamforming and first baseband beamforming; calculating a first matrix related to an input of the first radio frequency beamforming; designing second radio frequency beamforming on the basis of the first matrix; and designing second baseband beamforming on the basis of the second radio frequency beamforming.

### CROSS-REFERENCE TO RELATED APPLICATIONS

This application is a continuation of International Application No. PCT/KR2024/005147 designating the United States, filed on Apr. 17, 2024, in the Korean Intellectual Property Receiving Office and claiming priority to Korean Patent Application Nos. 10-2023-0089435, filed on Jul. 10, 2023, and 10-2023-0103465, filed on Aug. 8, 2023, in the Korean Intellectual Property Office, the disclosures of each of which are incorporated by reference herein in their entireties.

### BACKGROUND

### Field

The disclosure relates to a hybrid beamforming design method and a hybrid beamforming design device and, for example, to a hybrid beamforming design method and device for a massive MIMO OFDM system supporting multiple antennas and multiple users.

### Description of Related Art

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobile devices are expected to evolve into various formfactors, such as augmented reality glasses, virtual reality headsets, and hologram devices.

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latency one-tenth of 5G mobile communication technologies. Furthermore, in the 6G mobile communication technologies, communication methods using upper-mid bands (e.g., 7 GHz to 24 GHz bands) have been considered to extend coverage using massive antenna arrays.

In the 5G mobile communication technologies, in order to support services and to satisfy performance requirements in connection with enhanced Mobile BroadBand, (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in ultrahigh frequency bands, numerology (for example, operating multiple subcarrier spacings) for efficiently utilizing ultrahigh frequency resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

The massive MIMO systems are systems considered in 5G NR, which are expected to obtain. along with array gain, spatial multiplexing gain and diversity gain through beamforming technologies, thereby improving transmission/reception performance. In 6G, communication systems which utilizes extreme large-scale MIMO (XL-MIMO) using more antennas than massive MIMO are also under discussion.

### SUMMARY

Embodiments of the disclosure may provide a design method and a device for a hybrid beamforming capable of increasing a data transfer rate by integrating advantages of digital beamforming and advantages of analog beamforming.

A hybrid beamforming design method according to an example embodiment of the disclosure includes: designing first radio frequency beamforming (RF BF), designing first baseband beamforming (BB BF), based on the first radio frequency beamforming.

In an example embodiment, the method may further include: calculating a first performance index, based on the first radio frequency beamforming and the first baseband beamforming, calculating a first matrix associated with an input of the first radio frequency beamforming, designing second radio frequency beamforming, based on the first matrix, and designing second baseband beamforming, based on the second radio frequency beamforming.

A method and a device according to an example embodiment of the disclosure may provide an effect of optimizing a transmission rate while mitigating spatial constraint disadvantages of digital beamforming.

A method and a device according to an example embodiment of the disclosure may provide a design method and a device that are generally applicable to various phase shift network structures of a base station and a user equipment.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating example structures of digital beamforming, analog beamforming, and hybrid beamforming according to various embodiments.

FIG. 2 is a diagram illustrating an example connection structure of an antenna and an RF chain according to a type of hybrid beamforming according to various embodiments.

FIG. 3 is a flowchart illustrating an example hybrid beamforming design method according to various embodiments.

FIG. 4 is a diagram illustrating an example transmission process of a base station having a hybrid beamforming structure according to various embodiments.

FIG. 5 is a diagram illustrating an example reception process of a multi-antenna user having a hybrid beamforming structure according to various embodiments.

FIG. 6 is a diagram illustrating an initial RF BF design algorithm for hybrid beamforming design according to various embodiments.

FIG. 7 is a diagram illustrating an initial RF BF design algorithm for hybrid beamforming design according to various embodiments.

FIG. 8 is a diagram illustrating an initial RF BF design algorithm for hybrid beamforming design according to various embodiments.

FIG. 9 is a diagram illustrating an initial RF BF design algorithm for hybrid beamforming design according to an embodiment of the disclosure.

FIG. 10 is a diagram illustrating an RF BF update algorithm for hybrid beamforming design according to various embodiments.

FIG. 11 is a diagram illustrating an RF BF update algorithm for hybrid beamforming design according to various embodiments.

FIG. 12 is a diagram illustrating an RF BF update algorithm for hybrid beamforming design according to various embodiments.

FIG. 13 is a diagram illustrating an RF BF update algorithm for hybrid beamforming design according to various embodiments.

FIG. 14 is a diagram illustrating an RF BF update algorithm for hybrid beamforming design according to various embodiments.

FIG. 15 is a diagram illustrating an RF BF update algorithm for hybrid beamforming design according to various embodiments.

FIG. 16 is a diagram illustrating an initial RF BF update algorithm for hybrid beamforming design according to various embodiments.

FIG. 17 is a diagram illustrating an initial RF BF update algorithm for hybrid beamforming design according to various embodiments.

FIG. 18 is a flowchart illustrating an example hybrid beamforming design method according to various embodiments.

FIG. 19 is a diagram illustrating an example of resource allocation when SU-MIMO and MU-MIMO coexist for each frequency resource according to various embodiments.

FIG. 20 is a diagram illustrating an example of a base station UPA structure of a CDL channel model according to various embodiments.

FIG. 21 is a diagram illustrating an example of a user UPA structure of a CDL channel model according to various embodiments.

FIG. 22 is a flowchart illustrating an example hybrid beamforming design method according to various embodiments.

FIG. 23 is a flowchart illustrating an example hybrid beamforming design method according to various embodiments.

FIG. 24 is a flowchart illustrating an example hybrid beamforming design method according to various embodiments.

FIG. 25 is a block diagram illustrating an example configuration of a user equipment according to various embodiments.

FIG. 26 is a block diagram illustrating an example configuration of a base station according to various embodiments.

### DETAILED DESCRIPTION

Embodiments of the disclosure may address the above-mentioned problems and/or disadvantages and provide advantages as described below. An aspect of the disclosure may provide a terminal and a communication method thereof in a wireless communication system.

The terms used in the disclosure are used merely to describe various example embodiments, and may not be intended to limit the scope of the disclosure. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various example embodiments of the disclosure will be described based on an approach of hardware. However, various embodiments of the disclosure include a technology that uses both hardware and software, and thus the various embodiments of the disclosure may not exclude the perspective of software.

Various embodiments of the disclosure will be described using terms employed in some communication standards (e.g., the 3rd generation partnership project (3GPP)), but they are for illustrative purposes only. Various embodiments of the disclosure may also be easily applied to other communication systems through modifications.

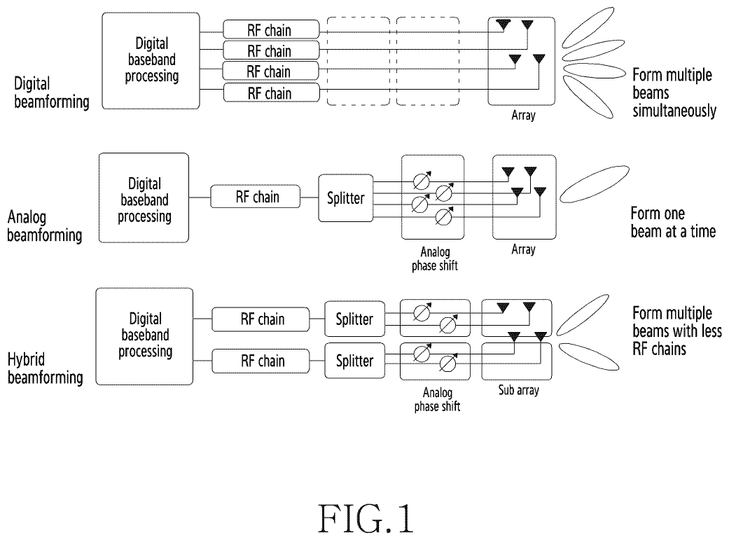

FIG. 1 is a diagram illustrating example structures of digital beamforming, analog beamforming, and hybrid beamforming according to various embodiments.

In relation to beamforming technologies, when a multiple-antenna system such as an adaptive array antenna or a smart antenna system has emerged, beamforming has evolved from mechanical beamforming of moving an antenna array to electronic beamforming by controlling phase shifters connected to each antenna. A technology for forming a beam by a phase shifter is referred to as analog beamforming, and a technology for controlling not only a phase of a transmission/reception signal but also a magnitude is referred to as digital beamforming. Although more reliable communication has become possible through digital beamforming that allows for signal amplitude control, implementing digital beamforming requires radio frequency (RF) chains for each antenna element, and this has been a drawback in terms of space constraints due to the increased hardware and power consumption caused by the components in the RF chains. Therefore, a hybrid beamforming (HBF) technology for compensating for the disadvantages of digital beamforming has attracted attention.

Hybrid beamforming technology may refer, for example, to a beamforming technology having a structure that uses fewer RF chains than antenna elements. Hybrid beamforming may refer, for example, to a beamforming technology in which analog beamforming is performed through a phase shifter connected to the antenna elements and the RF chains and digital beamforming is performed by controlling the magnitude and phase of a signal at the baseband.

On the other hand, digital beamforming (fully digital (FD) beamforming (BF)) may have the same number of antenna elements as the number of RF chains, all the antenna elements may be connected to the RF chains, and the phase and magnitude of a signal may be controllable. FIG. 1 illustrates various example types of beamforming in a multi-antenna system.

The term “beamforming” has originally indicated beam formation through phase shifter control without including a multiplexing function, but recently, beamforming has become a concept that includes precoding and combining technologies that enable multiplexing by forming multiple beams and enable multiplexing at the transmitter and receiver. For example, the preprocessing or postprocessing process to suppress interference occurring in the spatial domain or to enhance gain may be comprehensively referred to as beamforming technology.

Referring to FIG. 1, digital beamforming is a structure in which each antenna element is connected to an RF chain, and multiple beams may be formed simultaneously. In the case of digital beamforming, an RF chain is required for each antenna element due to its structure, which may result in space constraints and power consumption due to increased hardware.

In the case of analog beamforming, a phase shifter is located between the antenna element and the RF chain to control the phase of the transmitted/received signals, and multiple antenna elements may be connected to one RF chain to generate one beam at a time. Analog beamforming may control the phase of the signal but not its size, so it may be less reliable than digital beamforming.

Hybrid beamforming is an intermediate structure between digital beamforming and analog beamforming, in which multiple antenna elements are connected to phase shifters and RF chains, may include multiple RF chains, and may form multiple beams with fewer RF chains as compared to digital beamforming.

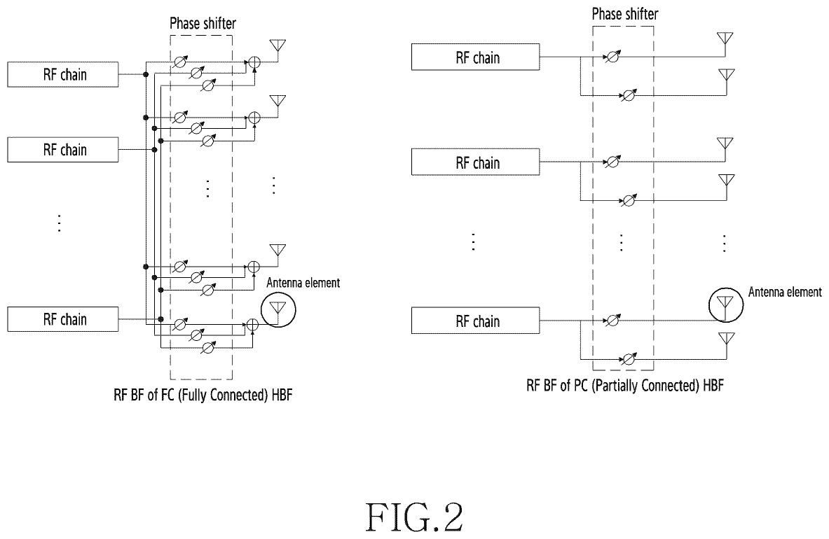

FIG. 2 is a diagram illustrating an example connection structure of an antenna and an RF chain according to a type of hybrid beamforming (HBF) according to various embodiments. FIG. 2 compares the structures of radio frequency beamforming (RF beamforming or RF BF) according to the types of hybrid beamforming (HBF).

Hybrid beamforming structures are largely divided into two types depending on the connection structure between antenna elements and RF chains. The connection structure between the antenna elements and RF chains is called a phase shift network (PSN), and in hybrid beamforming, the PSN may include two types.

The first PSN is a fully connected PSN (or FC-PSN), in which all RF chains are connected to all antenna elements through phase shifters, and a hybrid beamforming (HBF) structure with such a PSN may be referred to as a fully connected hybrid beamforming (or FC-HBF).

The second PSN is a partially connected PSN (or PC-PSN), in which each antenna element is connected to a single RF chain through a phase shifter, and a hybrid beamforming structure having such a PSN may be referred to as partially connected hybrid beamforming (or PC-HBF) or sub-array hybrid beamforming (sub-array HBF). In addition, some of the antenna elements may be connected to two or more RF chains, and such a case may also be referred to as a partially connected hybrid beamforming (PC-HBF) structure.

The 3GPP 5G NR also considers the HBF technology. However, the value of the phase shifter of the analog beamformer is fixed and thus is inflexible. According to an embodiment of the disclosure, the value of the phase shifter may be changed for more flexible communication.

Massive MIMO technology using HBF is attracting attention due to the prospect of wireless communication technology utilizing the millimeter wave band that may use a wider bandwidth. The millimeter wave band has high losses due to carrier path loss and atmospheric absorption, but since the wavelength is short, a large number of antennas may be integrated in the same area. In addition, since the number of scatters in the millimeter wave band is limited, the HBF technology is also attracting attention as a promising technology, and there is a trend to apply the massive MIMO technology to the existing RF band for the purpose of expanding coverage.

Referring to FIG. 2, in the fully connected hybrid beamforming (FC-HBF), the radio frequency (RF) beamforming (RF BF) structure is a structure in which multiple antenna elements are connected to all RF chains through phase shifters. In the case of the partially connected hybrid beamforming (PC-HBF) structure, each antenna element is connected to only one RF chain through a phase shifter. Such a structure in which the antenna elements and the RF chains are connected is referred to as a phase shift network structure and may be a fully connected structure or a partially connected structure.

A design method according to an embodiment of the disclosure describes a design method corresponding to a phase shift network (FC-HBF or PC-HBF structure) of a base station or a UE.

In an embodiment of the disclosure, Table 1 describes related terms. In addition, Table 2 describes notations of equations for describing an embodiment.

TABLE 1

| Term | Description |
|---|---|
| 5G NR (fifth generation new | 5G radio access technology |
| radio) | |
| AoA (angle of arrival) | Angle of arrival |
| AoD (angle of departure) | Angle of departure |
| AWGN (additive white Gaussian | Additive white Gaussian noise |
| noise) | |
| BB (baseband) | Baseband |
| BF (beamforming or beamformer) | Beamforming or beamformer |
| BS (base station) | Base station |
| CP (cyclic prefix) | Cyclic prefix |
| CSI (channel state information) | Channel state information |
| DFT (discrete Fourier transform) | Discrete Fourier transform |
| EGC (equal gain combining) | Equal gain combining |
| EGT (equal gain transmission) | Equal gain transmission |
| FC (fully-connected) | Fully-connected |
| FD (fully digital) | Fully digital |
| HBF (hybrid beamforming) | Hybrid beamforming |
| i.i.d (independent and identically | Independent and identically |
| distributed) | distributed |
| IDFT (inverse DFT) | Inverse discrete Fourier transform |
| ISI (inter-symbol-interference) | Inter-symbol-interference |
| LTE (long-term evolution) | Long-term evolution |
| Massive MIMO | Massive multiple-input multiple- |
| | output system |
| MIMO (multiple-input multiple- | Multiple-input multiple-output |
| output) | system |
| MMSE (minimum mean square | Minimum mean square error |
| error) | |
| MRT (maximum ratio | Maximum ratio transmission |
| transmission) | |
| MUI (multi-user interference) | Multi-user interference |
| MU-MIMO (Multi-user MIMO) | Multi-user multiple-input |
| | multiple-output system |
| OFDM (orthogonal frequency | Orthogonal frequency division |
| division multiplexing): | multiplexing |
| PC (partially connected) | Partially connected |
| PE (phase extraction) | Phase extraction |
| PMF (probability mass function) | Probability mass function |
| PSN (phase shift network) | Phase shift network |
| RF (radio frequency) | Radio frequency |
| SC (subcarrier) | Subcarrier |
| SCS (subcarrier spacing) | Subcarrier spacing |
| SINR (signal-to-interference-plus- | Signal-to-interference-plus-noise- |
| noise-ratio) | ratio |
| SLNR (signal-to-leakage-plus- | Signal-to-leakage-plus-noise- |
| noise-ratio) | ratio |
| SNR (signal-to-noise-ratio) | Signal-to-noise-ratio |
| SOTA (state-of-the-art) | State-of-the-art |
| SVD (singular value | Singular value decomposition |
| decomposition) | |
| THz (tera-hertz) | Tera-hertz |
| UB (upper bound) | Upper bound |
| UE (user equipment) | User equipment |
| ULA (uniform linear array) | Uniform linear array |
| UPA (uniform planar array) | Uniform planar array |
| XL-MIMO (extreme large-scale | Extreme large-scale multiple- |
| MIMO) | input multiple-output |

TABLE 2

| Symbol | Description |
|---|---|
| [symbol] | Real number field |
| [symbol] ₊ | Non-negative real number field |
| [symbol] | Complex number field |
| \|a\| | Absolute value of scalar a |
| ∠(a) | Function extracting phase of a |
| a[m] | mₜₕ element of vector a |
| \|\|a\|\|₂ | Euclidean norm of vector a |
| A | Matrix A |
| A⁻¹ | Inverse matrix of square matrix A |
| A^{†} | Pseudo-inverse matrix of matrix A |
| A(m, n) | (m, n) element of matrix A |
| A(m, :) | mₜₕ row vector of matrix A |
| A(:, n) | nₜₕ column vector of matrix A |
| A(:, 1: n) | Matrix including first n columns of matrix A |
| A^{T} or a^{T} | Transpose of matrix A or transpose of vector a |
| A^{H} or a^{H} | Conjugate transpose of matrix A or conjugate |
| | transpose of vector a |
| \|\|A\|\|_{F} | Frobenius norm of matrix A |
| Tr[A] | Trace of matrix A |
| \|A\| | Determinant of matrix A |
| diag(a,b,c) | Diagonal matrix with a, b, c as diagonal |
| | matrices |
| Bdiag(A, B, C) | Block diagonal matrix with matrices A, B, C as |
| | diagonal matrices |
| I_{N} | N × N identity matrix |
| k | Subcarrier index |
| K | Total number of subcarriers |
| ρ | CP ratio of OFDM |
| m_{TX} | Antenna element index of base station |
| M_{TX} | Total number of transmission antenna |
| | elements of base station |
| ${n}_{RF}^{TX}$ | Base station RF chain index |
| ${N}_{RF}^{TX}$ | Number of base station RF chains |
| P_{BS} | Total transmission power limit of base station |
| | per subcarrier |
| u | User index |
| U | Total number of users |
| M_{RX,u} | Number of reception antennas of user u |
| ${N}_{RF , u}^{RX}$ | Number of RF chains of user u |
| ${σ}_{n}^{2}$ | Variance of AWGN per subcarrier |
| [symbol] (m, Σ) | Complex Gaussian distribution with mean m |
| | and covariance matrix Σ |
| l_{u,k} | Data stream index of user u on kₜₕ subcarrier |
| L_{u,k} | Number of data streams of user u to be |
| | transmitted through kₜₕ subcarrier |
| s_{u,k} ∈ [symbol] ^{L}^{_{u,k}}^{×1} | Data streams of user u to be transmitted |
| | through kₜₕ subcarrier |
| ${s}_{k} ∈ {ℂ}^{{\sum }_{u = 1}^{U} {L}_{u , k} \times 1}$ | Data streams of all users to be transmitted |
| | through kₜₕ subcarrier |
| ${F}_{BB , u , k} ∈ {ℂ}^{{N}_{RF}^{TX} \times {L}_{u , k}}$ | Baseband BF matrix for s_{u,k} |
| ${F}_{BB , k} ∈ {ℂ}^{{N}_{RF}^{TX} \times {\sum }_{u = 1}^{U} {L}_{u , k}}$ | Baseband BF matrix for sk, |
| | including {F_{BB,u,k}, ∀u} |
| ${u}_{k} ∈ {ℂ}^{{N}_{R F}^{TX} \times 1}$ | BB precoded data of kₜₕ subcarrier |
| ${v}_{{n}_{RF}^{TX}} ∈ {ℂ}^{K \times 1}$ | $BB precoded data of {n}_{{RF}^{th}}^{TX} RF chain$ |
| ${F}_{R F} ∈ {ℂ}^{{M}_{T X} \times {N}_{R F}^{TX}}$ | RF BF matrix of base station |
| [symbol] | Set of RF BF matrices satisfying RF BF |
| | constraint of base station |
| ${TX}_{( {n}_{RF}^{TX} )}^{}$ | $Set of antenna indices connected to {n}_{RF}^{TX} RF$ |
| | chain when base station has PC-HBF structure |
| ${S}_{TX}^{( {n}_{RF}^{TX} )}$ | $Matrix representing connection between {n}_{RF}^{TX}$ RF chain and antenna when base station has |
| | PC-HBF structure |
| ${P}_{R F} ∈ {ℂ}_{+}^{{N}_{R F}^{T X} \times {N}_{R F}^{T X}}$ | Input signal power covariance matrix of RF chain |
| F_{u,k} ∈ [symbol] ^{M}^{_{TX}}^{×L}^{_{u,k}} | HBF matrix of base station for transmitting |
| | data stream of user u on kₜₕ subcarrier |
| \tilde{X} ∈ [symbol] ^{M}^{_{TX}}^{×(1+ρ)K} | Signal finally transmitted from base station |
| | after going through RF BF |
| T_{K} ∈ [symbol] ^{K×K} | K-point DFT unitary matrix |
| T_{K}^{H} ∈ [symbol] ^{K×K} | K-point IDFT unitary matrix |
| ${W}_{RF , u} ∈ {ℂ}^{{M}_{RX , u} \times {N}_{RF , u}^{RX}}$ | RF BF matrix of user u |
| ${u}_{} ∈ {ℂ}^{{M}_{RX , u} \times {N}_{RF , u}^{RX}}$ | Set of RF BF matrices satisfying RF BF constraints of user u |
| ${u}_{( {n}_{RF , u}^{RX} )}^{}$ | $Set of antenna indices connected to {n}_{RF , {u}^{th}}^{RX} RF$ |
| | chain when user u has PC-HBF structure |
| ${u}_{( {n}_{RF , u}^{RX} )}^{}$ | $Set of antenna indices connected to {n}_{RF , {u}^{th}}^{RX} RF$ |
| | chain when user u has PC-HBF structure |
| ${S}_{u}^{( {n}_{RF , u}^{RX} )}$ | Matrix representing connection between |
| | ${n}_{RF , {u}^{th}}^{RX} RF chain and antenna when user u has$ |
| | PC-HBF structure |
| ${W}_{BB , u , k} ∈ {ℂ}^{{N}_{RF , u}^{RX} \times {L}_{u , k}}$ | BB BF matrix of user u for kₜₕ subcarrier data |
| | detection |
| ${W}_{BB , u , k}^{( {l}_{u , k} )} ∈ {ℂ}^{{L}_{u , k} \times 1}$ | BB BF matrix for l_{u,k}_{^{th}} data stream of kₜₕ |
| | subcarrier |
| W_{u,k} ∈ [symbol] ^{M}^{_{RX,u}}^{×L}^{_{u,k}} | HBF matrix of user u for kₜₕ subcarrier data |
| | detection |
| n_{u,k} ∈ [symbol] ^{M}^{_{RX,u}}^{×1} | kₜₕ subcarrier noise among AWGN at antenna |
| | of user u |
| N_{CL,u} | Number of scatterer clusters in channel of user |
| | u |
| N_{ray,u} | Number of rays per scatterer cluster in channel |
| | of user u |
| D_{c,r,u} | Time delay of rₜₕ ray in Cₜₕ cluster of user |
| | channel u |
| α_{c,r,u} | Complex channel gain of rₜₕ ray in Cₜₕ cluster |
| | of user channel u |
| ${ϕ}_{c , r , u}^{UE}$ | AoA of rₜₕ ray in Cₜₕ cluster of user channel u |
| ${ϕ}_{c , r , u}^{BS}$ | AoD of rₜₕ ray in Cₜₕ cluster of user channel u |
| a_{UE,u} (·) | Array response vector of user u |
| a_{BS}(·) | Array response vector of base station |
| \tilde{H}_{u,d} ∈ [symbol] ^{M}^{_{RX,u}}^{×M}^{_{TX}} | Channel on dₜₕ delay tap of channel between |
| | user u and base station |
| H_{u,k} ∈ [symbol] ^{M}^{_{RX,u}}^{×M}^{_{TX}} | Channel on kₜₕ subcarrier of channel between |
| | user u and base station |
| Rᵤ | Transmission rate of user u |
| R | Total transmission rate of entire system |

According to an embodiment of the disclosure, a hybrid beamforming (HBF) design method may design an ideal beamforming matrix F_{ideal} (generally an FD BF matrix) and jointly design the RF BF F_{RF} and the BB BF F_{BB} so as to minimize the Frobenius norm between the HBF and the corresponding matrix. The transmission beamforming design objective in fully connected HBF may be represented by the following equation:

$$\{ {F}_{RF}^{opt} , {F}_{BB}^{opt} \} = arg {min}_{\{ {F}_{RF} , {F}_{BB} \}} {‖ {F}_{ideal} - {F}_{RF} {F}_{BB} ‖}_{F}^{2} ,$$

subject to |F_{RF}(i,j)|=constant, ∀(i,j) and

$${‖ {F}_{RF} {F}_{BB} ‖}_{F}^{2} \leq P .$$

In the above equation, ∥⋅∥_{F} refers to a Frobenius norm, and the two constraints represent the constant amplitude of the phase shifter and the total transmission power limit, respectively.

According to an embodiment, the design method may be one that approximates F_{ideal} using the orthogonal matching pursuit (OMP) algorithm, or one that designs the RF BF (F_{RF}) within size constraints (designing F_{RF} through phase extraction) while maintaining the phase of each element of F_{ideal} and one that designs the BB BF F_{BB} using the least squares (LS) method.

According to an embodiment, there is a manifold optimization-based alternative minimization (MO-AltMin) design method. This method alternately designs the RF BF and the BB BF, and the entire beamforming design process is iteratively performed. For a given F_{ideal} and a designed F_{RF} at the kₜₕ iteration,

$${F}_{RF}^{( k )} ,$$

BB BF at the corresponding iteration time point may be obtained through the LS method. That is,

$${F}_{BB}^{( k )} = {F}_{RF}^{( k ) †} {F}_{ideal} and {F}_{RF}^{( k + 1 )}$$

are obtained using the given F_{ideal} and

$${F}_{RF}^{( k )}$$

through Manifold optimization.

$${F}_{RF}^{( k ) †}$$

is pseudo-inverse of

$${F}_{RF}^{( k )} .$$

If the entire algorithm satisfies the convergence condition, the design is terminated, and the F_{RF} obtained through the iteration and F_{BB} are finally normalized to satisfy the transmission power limit.

In HBF design for single-user MIMO (SU-MIMO) in the frequency flat channel, phase extraction (PE) AltMin may be used as a design method to reduce the complexity of MO-AltMin. The phase extraction (PE) AltMin method also proceeds with the design process iteratively, and the RF BF and BB BF are alternately designed.

PE-AltMin assumes that F_{BB} is a scaled unitary matrix using the fact that the columns of the optimal fully digital BB BF F_{ideal} in SU-MIMO are orthogonal to each other. Accordingly, when

$${F}_{RF}^{( k )}$$

that is F_{RF} designed in the kₜₕ iteration and F_{ideal} are given,

$${F}_{BB}^{( k )} = {U}^{( k )} {V}_{1}^{{( k )}^{H}}$$

is designed based on the singular value decomposition (SVD) result

$${F}_{ideal}^{H} {F}_{RF}^{( k )} = {U}^{( k )} {S}^{( k )} {V}_{1}^{{( k )}^{H}} of {F}_{ideal}^{H} {F}_{RF}^{( k )} .$$

$${F}_{RF}^{( k + 1 )}$$

is designed through the PE of matrix

$${F}_{ideal} {F}_{BB}^{( k )} .$$

If the entire algorithm satisfies the convergence condition, the design is terminated, and the F_{RF} obtained through the iteration and F_{BB} are finally normalized to satisfy the transmission power limit.

The design method described above alternately and iteratively designs RF BF and BB BF, so that RF BF and BB BF may be designed complementarily during the design process.

According to an embodiment of the disclosure, the hybrid beamforming (HBF) design method may design RF BF, consider the product of the channel matrix and the RF BF matrix as an equivalent BB channel, and design BB BF using the corresponding channel as a previously known FD BF solution.

According to the above design method, the RF BF design method may be as follows.
1) A method of designing RF BF in a phase extraction (PE) format, which extracts the phases of the elements of the eigenvectors of the channel covariance matrix.
2) A method of designing RF BF from the phase of the radio channel matrix using the principle of equal gain transmission (EGT) or equal gain combining (EGC).
3) A method of designing a beam with a high correlation with the radio channel matrix among beam candidates in a prespecified RF BF codebook as RF BF.
4) A method of designing dominant ARVs as RF BF when the array response vector (ARV) is known through the antenna array.
5) A method of designing RF BF to maximize the capacity of the equivalent BB by assuming a very high signal-to-noise-ratio (SNR).

The above design method may design BB BF using the existing known FD BF solution, but the BB BF design result does not affect the RF BF design.

According to an embodiment of the disclosure, a hybrid beamforming (HBF) design method is a design method for a massive MIMO OFDM system supporting multiple antennas and multiple users, which is a method that considers the relationship between RF BF design and BB BF design, and may improve performance as compared to a result of a conventional hybrid beamforming design.

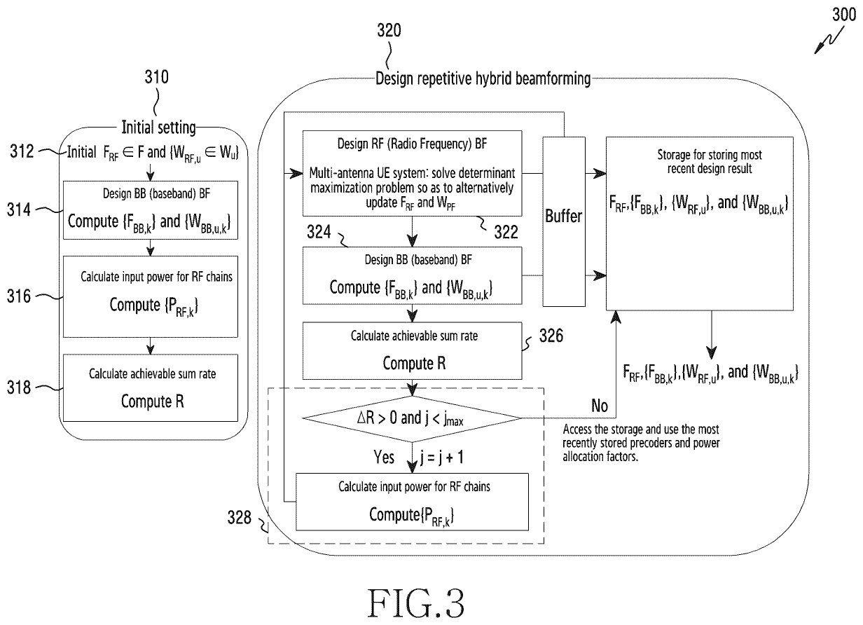

FIG. 3 is a flowchart illustrating an example hybrid beamforming design method according to various embodiments.

Referring to FIG. 3, a hybrid beamforming design method 300 according to an embodiment of the disclosure may include an initial setup operation 310 and an iterative design operation 320.

The initial setup operation 310 includes an operation 312 of designing initial (or first) RF BF (F_{RF} and W_{RF}), an operation 314 of designing BB BF (F_{BB} and W_{BB}), an operation 316 of calculating input power (P_{RF}) (or input signal power) for an RF chain, and an operation 318 of calculating a performance index (e.g., sum rate).

The iterative design operation 320 may include an operation 322 of designing RF BF, an operation 324 of designing BB BF, an operation 326 of calculating a performance index (e.g., sum rate), and an operation 328 of calculating an input power (or input signal power) for the RF chains corresponding to a result of the calculated performance index.

328 may calculate the input power P_{RF} (or input signal power) for the RF chain when the number of design iterations is less than a maximum number of iterations (j_max) or the calculated performance index is better than a previously calculated performance index (ΔR>0).

The iterative design operation 320 may iteratively design the RF BF or the BB BF by comparing a calculated performance index with a previously calculated performance index. In addition, the design may be iterated based on a configured maximum number of iterations (j_max) or the design may be terminated when the newly designed HBF no longer increases the performance index (ΔR<0).

When the design is terminated, the result of the beamformer design may be determined by the most recently designed and stored value in the storage.

The RF BF design operation 322 may design the RF BF in a direction of maximizing an upper bound (UB) of an achievable sum rate of an equivalent BB channel by considering an RF chain as a virtual antenna. Therefore, the influence of the BB BF may be considered in the design of the RF BF. The output signal of the BB BF is an input signal from the RF chain's perspective, and thus the output signal power of the BB BF may be considered as an input power matrix when designing the RF BF.

The BB BF design operation 324 may design the BB BF using the FD BF design solution using an equivalent BB channel.

The hybrid beamforming design method 300 described in FIG. 3 may represent a design method for a case in which both the base station and the UE have HBF structures.

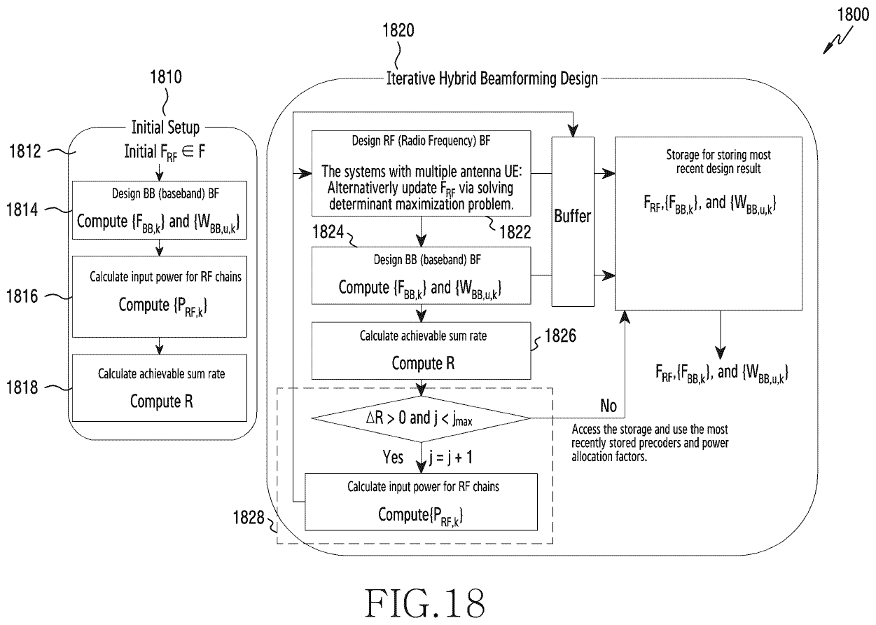

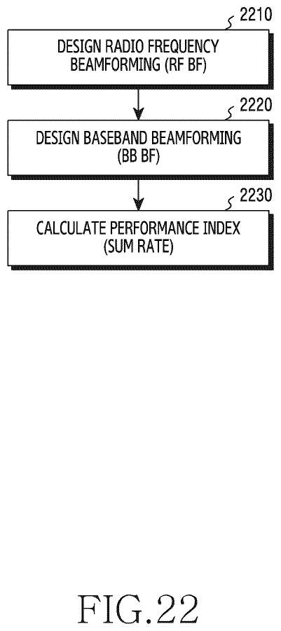

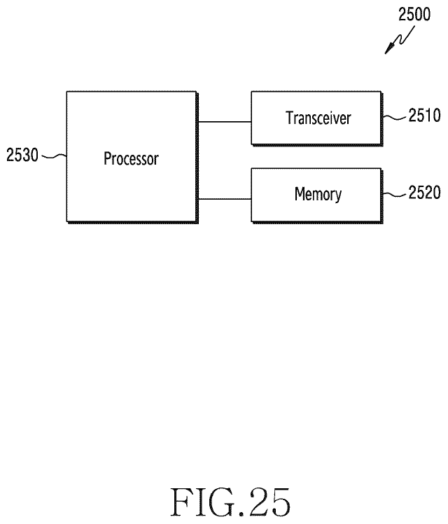

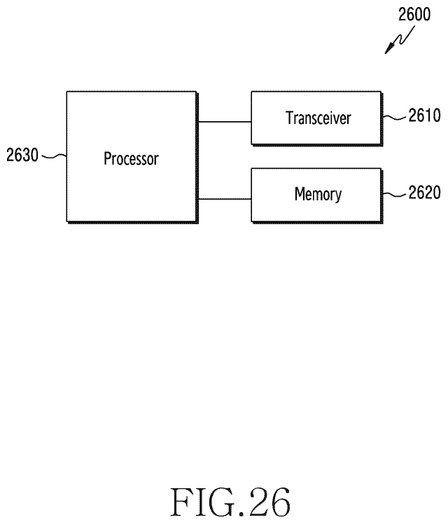

The design method 300 of FIG. 3 may correspond to the design method 1800 of FIG. 18 and the design methods described in FIGS. 22 to 24. The design method may be a design method performed by the UE of FIG. 25 or the base station of FIG. 26.

As described above, 300 may design the BB BF and the RF BF complementarily to each other in consideration of the input signal power of the RF chain. In addition, the design method is also applicable in a case where the number of RF chains of the base station is greater than the total number of RF chains of users and a case where the hybrid beamforming structures of the base station and users are PC-HBF or FC-HBF.

The design method may also be applied to a system in which frequency resources for SU-MIMO and frequency resources for MU-MIMO coexist, and thus has high applicability, and also exhibits good performance in terms of sum rate performance.

Hereinafter, a Massive MIMO OFDM downlink system supporting multiple antennas and multiple users will be described in relation to an example embodiment.

The disclosure considers a single-cell downlink system, and the base station may include a massive antenna array. The number of base station antenna elements (or antennas) is M_{TX} and the number of RF chains is

$${N}_{RF}^{TX} < {M}_{TX} .$$

That is, the base station has a hybrid beamforming structure in which the number of RF chains is smaller than the number of antennas.

RF chains and antennas are connected to phase shifters in the base station. It is assumed that the phase shift network (PSN) has a fully connected structure, and a partially connected structure will be described separately.

In the base station, the RF BF is represented by

$${F}_{RF} ∈ {ℂ}^{{M}_{TX} \times {N}_{RF}^{TX}} ,$$

and in the fully connected HBF, the size of all elements of the corresponding matrix is the same, and for convenience, the size limit may be assumed to be

$$\frac{1}{\sqrt{{M}_{TX}}} .$$

### That is

$$\vert {F}_{RF} ( i , j ) \vert = \frac{1}{\sqrt{{M}_{TX}}} , ∀ ( i , j ) .$$

When the number of RF chains of the base station is equal to the number of antennas and the RF BF is an identity matrix, the base station has a fully digital (FD) BF structure.

In a partially connected (PC)-hybrid beamforming (HBF) structure,

$$γ = \frac{{M}_{TX}}{{N}_{RF}^{TX}}$$

is a natural number, and each RF chain is connected to y antennas and phase shifters. In this case, F_{RF} is a matrix having a value of

$$\sqrt{\frac{{N}_{RF}^{TX}}{{M}_{TX}}}$$

in magnitude at a location where the phase shifter exists and having 0 for the rest.

In an embodiment according to the disclosure, it is assumed that the user receives data through all subcarriers and desires a multiplexing gain as many as the number of RF chains

$$( {N}_{RF , u}^{RX} )$$

that the user owns in each subcarrier, and thus

$${L}_{u , k} = {N}_{RF , u}^{RX} , ∀ k$$

is assumed. However, the same may also be applied in the case of

$${L}_{u , k} \leq {N}_{RF , u}^{RX} , ∀ k .$$

Here, L_{u,k} may indicate the number of layers that user u desires to receive through the kₜₕ subcarrier. Therefore, the base station intends to transmit

$${\sum }_{u = I}^{U} {L}_{u , k}$$

pieces of data in every OFDM symbol period from all subcarriers.

In an embodiment according to the disclosure, a modulation method may include OFDM, the number of subcarriers (SCs) of OFDM may be K, and the SC index may be 1≤k≤K. In addition, the CP ratio, which is the ratio of the cyclic prefix (CP) to the total number of SCs, is p, and the CP length is sufficient to eliminate inter-symbol-interference (ISI) through CP removal at the receiver.

Since F_{RF}, the RF BF of the base station, is applied equally during the coherence time of the channel in the time domain, it has a frequency flat characteristic. Therefore, in order to support the OFDM system, BB BF capable of preprocessing data for each subcarrier is necessary.

A signal transmitted to a user through a radio channel may have AWGN added thereto at a receiver (user equipment), and the data may be detected after passing through hybrid beamforming for each user. The total number of users is U, and the index of a user is 1≤u≤U. The number of reception antennas of the user u is M_{RX,u}>1 and the number of RF chains satisfies

$$1 < {N}_{RF , u}^{R X} < {M}_{R X , u} .$$

In the following description, the user's HBF is assumed to have a fully connected HBF structure, and a partially connected structure will be separately mentioned and described.

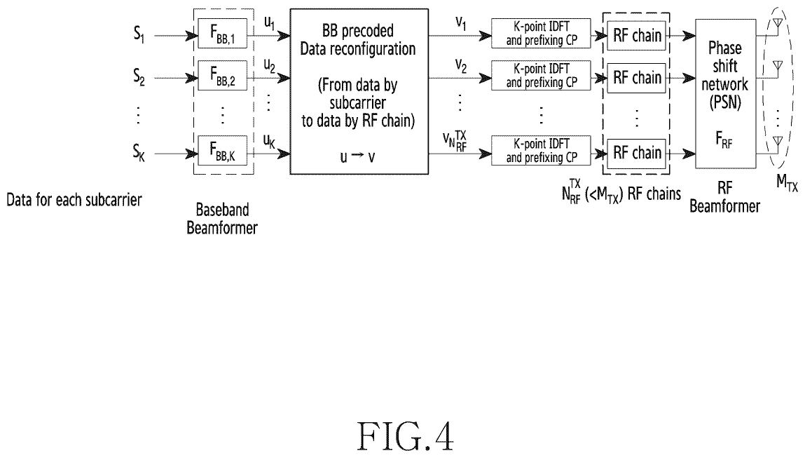

FIG. 4 is a diagram illustrating an example transmission process of a base station having a hybrid beamforming structure according to various embodiments. FIG. 4 may illustrate a signal processing process of the base station, and the transmission process of FIG. 4 may be performed by the base station of FIG. 26.

FIG. 4 illustrates a transmission block diagram of a hybrid beamforming base station in an OFDM massive MIMO system. The base station is assumed to have a fully connected HBF structure, and a description of a partially connected structure is separately mentioned. The antenna array of the base station is a ULA, but is not limited to the ULA.

In FIG. 4,

$${s}_{k} ∈ {ℂ}^{{\sum }_{u = 1}^{U} {L}_{u , k} \times 1}$$

indicates data streams of users to be transmitted through the kₜₕ subcarrier, and L_{u,k} indicates the number of data streams of user u to be transmitted through the kₜₕ subcarrier.

Since sₖ represents the data stream of all users, the data for each user follows an independent and identically distributed (i.i.d.) distribution, and if the distribution is a complex Gaussian distribution with a mean of 0, it may be expressed as follows.

$${s}_{k} = {[ {s}_{1 , k}^{T} , {s}_{2 , k}^{T} , … {s}_{U , k}^{T} ]}^{T} , where {s}_{u , k} ∼ 𝒞𝒩 ( 0 , {I}_{{L}_{u k}} ) . \qquad ( 1 )$$

The user receives data through all subcarriers and assumes

$${L}_{u , k} = {N}_{RF , u}^{R X} , ∀ k$$

in hopes of multiplexing gain as many as the number of RF chains

$$( {N}_{NR , u}^{R X} )$$

the user has in each subcarrier. However, the same is also applicable in the case of

$${L}_{u , k} \leq {N}_{RF , u}^{R X} , ∀ k .$$

The data stream is subject to a precoding process through BB BF in priority. When the base station defines the BB BF matrix for

$${s}_{u , k} ∈ {ℂ}^{{L}_{u , k} \times 1}$$

as

$${F}_{BB , u , k} ∈ {ℂ}^{{N}_{R F}^{T X} \times {L}_{u , k}} ,$$

the kₜₕ SC data that has undergone BB BF may be expressed as follows.

$${u}_{k} = {\sum }_{u = 1}^{U} {F}_{B B , u , k} {s}_{u , k} = \underbrace{[ {F}_{B B , 1 , k} , {F}_{B B , 2 , k} , … , {F}_{B B , U , k} ]}_{{=}^{Δ} {F}_{BB , k} ∈ {ℂ}^{{N}_{R F}^{T X} \times {\sum }_{u = 1}^{U} {L}_{u , k}}} {s}_{k} ∈ {ℂ}^{{N}_{R F}^{T X} \times 1} . \qquad ( 2 )$$

Signal processing in the baseband is performed for each subcarrier, but the IDFT process for OFDM modulation and RF BF through PSN are performed for each RF chain, so the precoded data calculated by BB BF needs to be configured from data for each subcarrier to data for each RF chain. According to this process, the BB precoded data

$${v}_{{n}_{R F}^{T X}} ∈ {ℂ}^{K \times 1} of the {n}_{R {F}^{t h}}^{T X}$$

RF chain may be defined as follows.

$${v}_{{n}_{R F}^{T X}} = {[ {u}_{1} [ {n}_{R F}^{T X} ] , {u}_{2} [ {n}_{R F}^{T X} ] , … , {u}_{K} [ {n}_{R F}^{T X} ] ]}^{T} , for 1 \leq {n}_{R F}^{T X} \leq {N}_{R F}^{T X} . \qquad ( 3 )$$

Each

$${v}_{{n}_{R F}^{TX}} , ∀ {n}_{R F}^{T X}$$

passes through the K-point IDFT and CP addition process, passes through the RF chain, then performs time-domain signal processing through RF BF F_{RF} before being radiated from the transmit antenna elements. Since the CP ratio is ρ, the CP length is ρK. It is assumed that the radiation patterns of the base station antenna elements are isotropic.

The transmission power limit in the base station is applied as the same value for each subcarrier and is denoted by P_{BS}. Therefore, the HBF of the base station should satisfy the following.

$${‖ {F}_{R F} {F}_{B B , k} ‖}_{F}^{2} \leq {P}_{BS} , ∀ k . \qquad ( 4 )$$

The RF BF of the base station is assumed to have a fully connected PSN, and each element of F_{RF} is defined to have the same size, and a matrix set that satisfies the corresponding condition is defined as [symbol] .

That is,

$$\vert {F}_{R F} ( i , j ) \vert = \frac{1}{\sqrt{{M}_{T X}}} , ∀ ( i , j ) . \qquad ( 5 )$$

In addition,

$$ℱ = \{ {F}_{RF} ‖ {F}_{RF} ( i , j ) \vert = \frac{1}{\sqrt{{M}_{TX}}} , ∀ ( i , j ) \} .$$

Assuming a partially connected PSN, if a set of base station antenna indices connected to the

$${n}_{{RF}^{t h}}^{T X}$$

RF chain is defined as

$${𝒮}_{T X}^{( {n}_{R F}^{T X} )} , then ℱ = \{ {F}_{R F} ‖ {F}_{R F} ( i , j ) \vert = \{ \begin{matrix}\sqrt{\frac{{N}_{RF}^{TX}}{{M}_{TX}}} , if i ∈ {𝒮}_{TX}^{( j )} \\ 0 , otherwise\end{matrix} \} .$$

The signal transmitted through the transmission antenna after passing through the RF BF may be expressed in matrix form in the space-time domain as follows.

$$\tilde{X} = {F}_{R F} {V}^{T} {{T}_{K}^{H} [ \begin{matrix}{0}_{ρ K \times ( 1 - ρ ) K} , {I}_{ρ K} \\ {I}_{k}\end{matrix} ]}^{T} ∈ {ℂ}^{{M}_{T X} \times ( 1 + ρ ) K} . \qquad ( 6 )$$

In equation (6) above,

$$V {=}^{△} [ \begin{matrix}{v}_{1} , & … , & {v}_{{N}_{RF}^{TX}}\end{matrix} ] ∈ {ℂ}^{K \times {N}_{R F}^{T X}} and {T}_{K}^{H} ∈ {ℂ}^{K \times K}$$

is K-point IDFT unitary matrix.

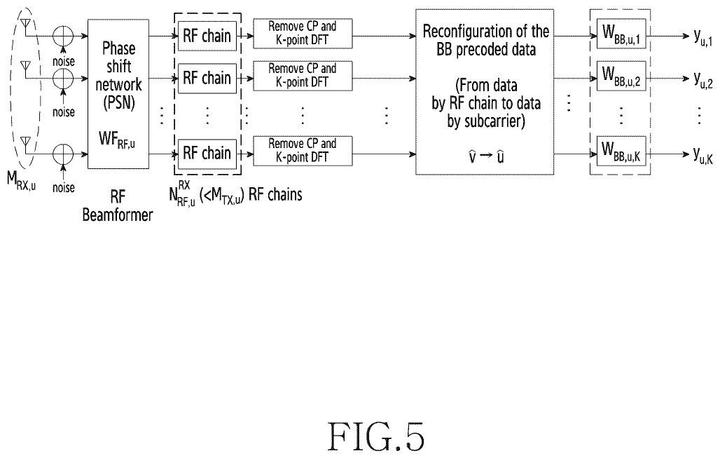

FIG. 5 is a diagram illustrating an example reception process of a multi-antenna user having a hybrid beamforming structure according to various embodiments. FIG. 5 may illustrate a signal processing process of a multi-antenna user having an HBF structure. The reception process of FIG. 5 may be performed by the user (UE) of FIG. 25.

The signal transmitted by the base station is transmitted to each user through a radio channel, and AWGN may be added to each of the users' reception antenna.

In the system according to an embodiment of the disclosure, since each user has an HBF structure, the signal to which AWGN has been added undergoes a time-domain signal processing process by the RF BF W_{RF,u}. Therefore, W_{RF,u} should satisfy the following condition. Like the base station, the PSN structure of each user is assumed to be a fully connected PSN, and a partially connected case is separately mentioned.

$$\vert {W}_{RF , u} ( i , j ) \vert = \frac{1}{\sqrt{{M}_{RX , u}}} , ∀ ( i , j ) . \qquad ( 8 )$$

If users have a PC-HBF structure having a partially connected PSN,

$$\frac{{M}_{RX , u}}{{N}_{RF , u}^{RX}}$$

is an integer, each RF chain is connected to

$$\frac{{M}_{RX , u}}{{N}_{RF , u}^{RX}}$$

antenna elements and a phase shifter, and W_{RF,u} is a matrix having a value of magnitude of

$$\sqrt{\frac{{N}_{RF , u}^{RX}}{{M}_{RX , u}}}$$

only at the location where the phase shifter exists and having 0 for the rest.

Signals that have passed through the RF BF pass through the RF chain and then undergo a CP removal process and a K-point DFT process. Through the DFT process, the received signals may be grouped for each subcarrier and the signals are detected by BB BFs designed for each subcarrier.

The BB BF used by the user u to detect information on the kₜₕ subcarrier may be defined as follows.

$${W}_{BB , u , k} = [ {w}_{BB , u , k}^{( 1 )} , {w}_{BB , u , k}^{( 2 )} , … , {w}_{BB , u , k}^{( {L}_{u , k} )} ] ∈ {ℂ}^{{N}_{RF , u}^{RX} \times {L}_{u , k}} . \qquad ( 9 )$$

In equation (9) above,

$${w}_{BB , u , k}^{( {L}_{u , k} )} ∈ {ℂ}^{{N}_{RF , u}^{R X} \times 1}$$

refers to the data of the l_{u,k}_{^{th}} stream existing in the kₜₕ subcarrier among the data of the user u.

Assuming that the CP length is long enough to completely eliminate ISI and that the time and frequency synchronization is perfect, the signal passing through BB W_{BB,u,k} is modeled as follows.

$${y}_{u , k} = {\underbrace{{W}_{u , k}^{H}}}_{= {W}_{BB , u , k}^{H} {W}_{RF , u}^{H}} {H}_{u , k} {\underbrace{{F}_{u , k}}}_{= {F}_{RF} {F}_{BB , u , k}} {s}_{u , k} + {W}_{u , k}^{H} {H}_{u , k} {\sum }_{{u}^{′} \neq u} {F}_{{u}^{′} , k} {s}_{{u}^{′} , k} + {W}_{u , k}^{H} {n}_{u , k} , ∀ ( u , k ) . \qquad ( 10 )$$

The items on the right side of the above equation (10) are described in order as follows.

The first term in equation (10) is a desired signal, and H_{u,k}∈ [symbol] ^{M}^{_{RX,u}}^{×M}^{_{TX}} may represent the channel on the kₜₕ subcarrier among the radio channels between the user u and the base station.

The second term in equation (10) represents inter-user interference (IUI), which may represent a factor in performance degradation.

The third term in equation (10) is the noise that has gone through the HBF process of the receiver, where n_{u,k}∈ [symbol] ^{M}^{_{RX,u}}^{×1} represents the AWGN added from the reception antenna of the user u, and may be modeled as follows.

$${n}_{u , k} ∼ 𝒞𝒩 ( {0}_{{M}_{RX , u} \times 1} , {σ}_{n}^{2} {I}_{{M}_{RX , u}} ) . \qquad ( 11 )$$

As shown in the equation (11) above, the variance of noise added from each antenna of the user follows a complex Gaussian distribution, the noise between antennas is independent of each other, the variance value is the same as

$${σ}_{n}^{2} ,$$

and the noise variance may have the same value for all users and subcarriers.

Hereinafter, a channel model and an expression according to a domain will be described.

When the number of scatterer clusters is limited, a channel corresponding to the dₜₕ delay tap of a channel between the user u and the base station may be expressed as follows according to the delay-d channel model.

$${\tilde{H}}_{u , d} = \sqrt{\frac{{M}_{T X} {M}_{RX , u}}{{N}_{CL , u} {N}_{ray , u}}} {\sum }_{c = 1}^{{N}_{CL , u}} {\sum }_{r = 1}^{{N}_{ray , u}} {α}_{c , r , u} δ ( d - {D}_{c , r , u} ) {{a}_{UE , u} ( {ϕ}_{c , r , u}^{UE} ) [ {a}_{B S} ( {θ}_{c , r , u}^{B S} ) ]}^{H} ∈ {ℂ}^{{M}_{RX , u} \times {M}_{T X}} . \qquad ( 12 )$$

In the above equation (12), it is assumed that

$${θ}_{l , r , u}^{BS}$$

is a random variable having the angle of departure (AoD) of the rₜₕ ray in the cₜₕ cluster of the channel between the user u and the base station and a mean of

$${θ}_{c , u}^{BS} ,$$

and follows a Laplacian distribution with an angular spread of

$${\overline{θ}}_{c , u}^{BS} .$$

It is assumed that

$${ϕ}_{c , r , u}^{UE}$$

is a random variable having the angle of arrival (AoA) of the rₜₕ ray in the cₜₕ cluster of the channel between the user u and the base station and a mean of

$${ϕ}_{c , u}^{UE} ,$$

and follows a Laplacian distribution with an angular spread of

$${\overline{ϕ}}_{c , u}^{UE} .$$

N_{CL,u} represents the number or scatterer clusters in the channel for the user u, and N_{ray,u} represents the number of rays per cluster.

In the above equation (12),

$${a}_{BS} ( {θ}_{c , r , u}^{BS} )$$

represents the antenna array response of the base station antenna array when the departure angle is

$${θ}_{c , r , u}^{BS} .$$

In the disclosure, a ULA is assumed such that there is one AoD per path, but the disclosure may be extended to a case in which the base station has an antenna array of a uniform planar array (UPA) type capable of three-dimensional beamforming. In the case of a UPA, the antenna array response vector may be configured by performing a Kronecker product of the antenna array responses according to each axis of the antenna array. Similarly,

$${a}_{UE , u} ( {ϕ}_{c , r , u}^{UE} )$$

is the antenna array response of the user u antenna array when the angle of arrival is

$${ϕ}_{c , r , u}^{UE} .$$

Each user may also be assumed to have a ULA, but a UPA may also be applied.

In the above equation (12), D_{c,r,u} represents the discrete time delay of the rₜₕ ray in the cₜₕ cluster of the channel between the user u and the base station, and 0≤D_{c,r,u}≤ρK to satisfy the ISI avoidance condition. In addition, rays within the same cluster may be located close to each other, so that different rays within the same cluster may be considered to cause the same time delay, as in the CDL channel model. That is, D_{c,1,u}=D_{c,2,u}= . . . =D_{c,N}_{_{ray,u}}_{,u}≙D_{c,u}.

The channel H_{u,k} on the kₜₕ subcarrier of the radio channel between user u and the base station is expressed as follows.

$${H}_{u , k} = {\sum }_{d = 0}^{ρ K} {\tilde{H}}_{u , d} {e}^{- j 2 π d \frac{( k - 1 )}{K}} . \qquad ( 13 )$$

Hereinafter, a performance index indicating the performance of a design method according to an embodiment will be described.

For example, the expression of transmission rate is described.

In an embodiment according to the disclosure, the expression for the transmission rate per user is as follows.

Since the reception signal is modeled as in equation (11), the transmission rate that user u may achieve according to the given HBF is as follows.

$${R}_{u} = \frac{{ρ}^{′}}{K} {\sum }_{k = 1}^{K} {log}_{2} \vert {I}_{{N}_{RF , u}^{RX}} + {Q}_{u , k}^{- 1} {W}_{u , k}^{H} {H}_{u , k} {F}_{u , k} {F}_{u , k}^{H} {H}_{u , k}^{H} {W}_{u , k} \vert . \qquad ( 14 )$$

In equation (14),

$${ρ}^{′} = \frac{1}{1 + ρ} ,$$

and the unit of the transmission rate is bps/Hz. In addition, in equation (14), matrix

$${Q}_{u , k} ∈ {ℂ}^{{N}_{RF , u}^{RX} \times {N}_{RF , u}^{RX}}$$

represents the covariance matrix sum of the interference and noise matrices, and is as follows.

$${Q}_{u , k} = {W}_{u , k}^{H} {H}_{u , k} [ {\sum }_{{u}^{′} \neq u} {F}_{{u}^{′} , k} {F}_{{u}^{′} , k}^{H} ] {H}_{u , k}^{H} {W}_{u , k} + {σ}_{n}^{2} {W}_{u , k}^{H} {W}_{u , k} . \qquad ( 15 )$$

An expression for the total transmission rate of the entire system according to an embodiment of the disclosure is as follows.

The total transmission rate of the entire system is

$$R = {\sum }_{u = 1}^{U} {R}_{u} ,$$

and a design method according to an embodiment of the disclosure is intended to design HBF that maximizes the total transmission rate.

A hybrid beamforming design method according to an embodiment of the disclosure may include an operation of designing RF BF, an operation of designing BB BF, and an operation of calculating an input signal of the RF BF.

An operation of designing RF BF according to an embodiment may correspond to 322 of FIG. 3. The designing RF BF according to an embodiment considers the base station and users' RF chains as virtual antennas, and designs the RF BF in a direction of maximizing a total transmission rate upper bound (UB) by considering the input signal power of the RF chains.

When both the base station and the UE have HBF structures, the base station's RF BF and the users' RF BF may be designed in the downlink. The design order of the RF BF according to an embodiment may be to design the RF BF of the base station first and then design the RF BF of the users, or vice versa. However, when designing the RF BF, the RF BF of the other party is fixed.

An operation of designing a baseband (BB) BF according to an embodiment may correspond to 324 of FIG. 3. In case that the HBF structure of the base station and the RF BF of the user are determined, the equivalent baseband (BB) channel matrix is obtained by multiplying the radio channel matrix and the RF BF matrix. In addition, the entire system may be considered as a wireless system in which the RF chain is an antenna and an equivalent baseband (BB) channel is a radio channel (however, when considering RF BF in the HBF system, the base station must satisfy a power limit).

Therefore, a design method according to an embodiment may design BB BF using an FD BF design principle in a multi-user MIMO (MU-MIMO) downlink system. The FD BF design methods that may be applied in the MU-MIMO system are as follows.
i) block diagonalization (BD)
ii) regularized block diagonalization (RBD) or regularized channel diagonalization (RCD)
iii) signal-to-leakage-and-noise ratio (SLNR) maximizing BF
iv) minimum mean square error (MMSE) BF
v) weighted MMSE (WMMSE) BF

In an embodiment of the disclosure, since a transmission power limit exists for each subcarrier, the transmission and reception relationship for each subcarrier may be considered as a transmission and reception relationship in a single-carrier modulation, and the above-described FD BF design method may be applied to the BB BF design.

An operation of calculating an input signal of RF BF according to an embodiment may correspond to 328 of FIG. 3.

A design method according to an embodiment is to perform the RF BF design and BB BF design in a mutually complementary manner. Therefore, in an iterative design process, the output signal power of the BB BF is calculated to consider the influence of the most recently designed BB BF when designing the RF BF. Since the output signal of the BB BF is the input signal of the RF chain, the process may be identical to calculating the input signal power of the RF chain. For example, this process may be calculating a matrix representing the output signal power of the BB BF or the input signal power of the RF chain.

A hybrid beamforming design method according to an embodiment requires an initial (or first) RF BF matrix. An arbitrary matrix satisfying the size limit for each element of the RF BF may be used as an initial matrix, or an RF BF matrix according to a different HBF design method may be used as initial RF BF.

A hybrid beamforming design method according to an embodiment provides an initial RF BF design method that complements a SOTA technique. The initial RF BF design method according to an embodiment may be applied to a communication system (a communication system in which the number of RF chains of the base station is greater than the total number of RF chains of the users) to which a SOTA technique is not applicable, and therefore has excellent versatility.

In an embodiment, the HBF design may terminate the design process and design a hybrid beamforming using the most recently stored design result when a performance index (e.g., total transmission rate (sum rate)) of a newly designed HBF does not exceed the performance of a previously designed HBF or when the number of design iterations exceeds a limited number.

In a hybrid beamforming design method according to an embodiment, the RF BF design operation optimizes its own RF BF of the receiver while fixing the RF BF of the other party (when designing the RF BF of the base station, the RF BF of the other party is the RF BFs of the users, and when designing the RF BF of the users, the RF BF of the other party is the RF BF of the base station). Therefore, initial RF BF is required.

The initial RF BF matrix may be any beamforming matrix that satisfies the RF BF constraint conditions, or may be RF BF designed by a different hybrid beamforming design method.

In the SOTA technique, the base station and users all have an FC-HBF structure, and each RF chain of the base station is paired with one of the RF chains of the users. Therefore, the SOTA technique is applied in a case where the number of RF chains of the base station is the same as the total number of RF chains of the users.

The RF BF design method with the SOTA technique designs an RF beam pair that has a high correlation with the sum of the Gramian matrices of all SC channels in order for each RF pair using a power iteration method. However, for each RF beam pair design, residual channels are orthogonally projected onto the space generated by the designed RF beam pair, and then the orthogonally projected channels are removed so that the RF beam pairs formed subsequently are quasi-orthogonal to the previously generated RF beam pair.

A design method according to an embodiment of the disclosure provides a method for designing initial RF BF, which is applicable even when the number of RF chains of the base station is greater than the total number of the users' RF chains, thereby complementing the SOTA technique. In addition, an RF BF design method applicable to four possible cases (FC-HBF/FC-HBF, PC-HBF/FC-HBF, FC-HBF/PC-HBF, and PC-HBF/PC-HBF) related to HBF structures of the base station and the UE is disclosed.

Hereinafter, a first (initial) RF beamforming (BF) design method according to an embodiment will be described.

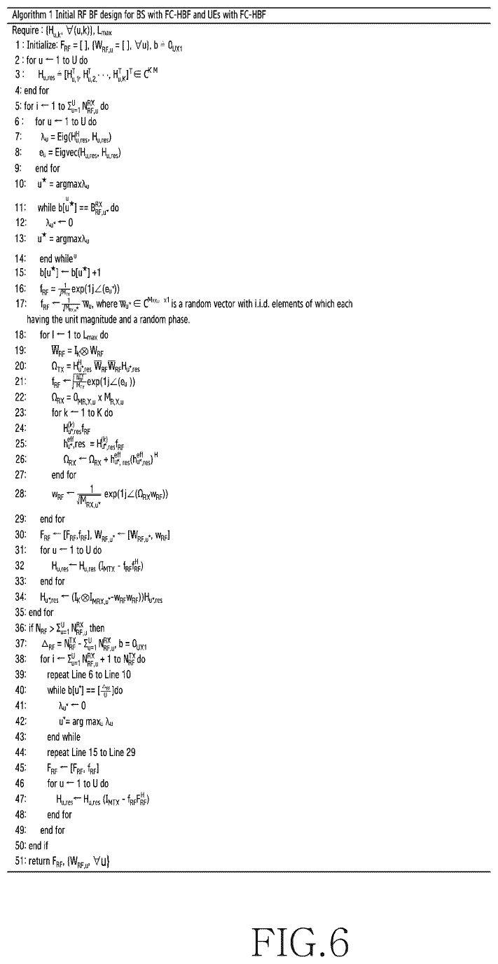

FIGS. 6, 7, 8 and 9 are diagrams illustrating example algorithms for designing initial RF BF according to various embodiments.

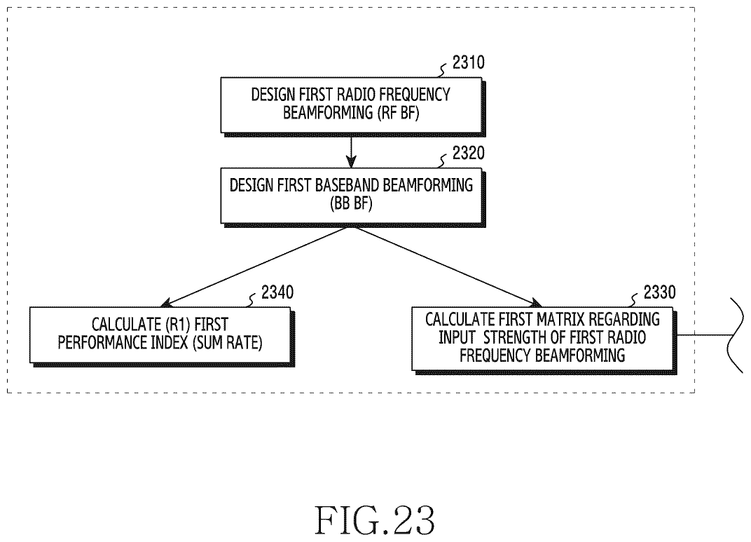

FIG. 6 illustrates an example initial RF BF design algorithm for hybrid beamforming design according to an embodiment of the disclosure. FIG. 6 illustrates an algorithm representing an initial RF BF design method under the conditions of the FC-HBF base station and FC-HBF users. FIG. 6 may correspond to 312 of FIG. 3, 2210 of FIG. 22, or 2310 of FIG. 23, and the algorithm may be performed by the user of FIG. 25 or the processor of the base station of FIG. 26.

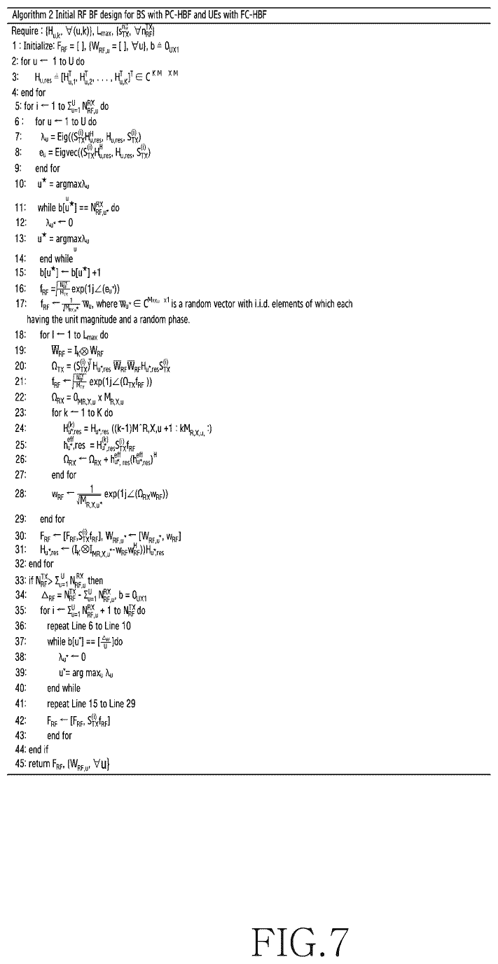

FIG. 7 illustrates an example initial RF BF design algorithm for hybrid beamforming design according to an embodiment of the disclosure. FIG. 7 illustrates an algorithm representing an initial RF BF design method under the conditions of the PC-HBF base station and FC-HBF users. FIG. 7 may correspond to 312 of FIG. 3, 2210 of FIG. 22, or 2310 of FIG. 23, and the algorithm may be performed by the user of FIG. 25 or the processor of the base station of FIG. 26.

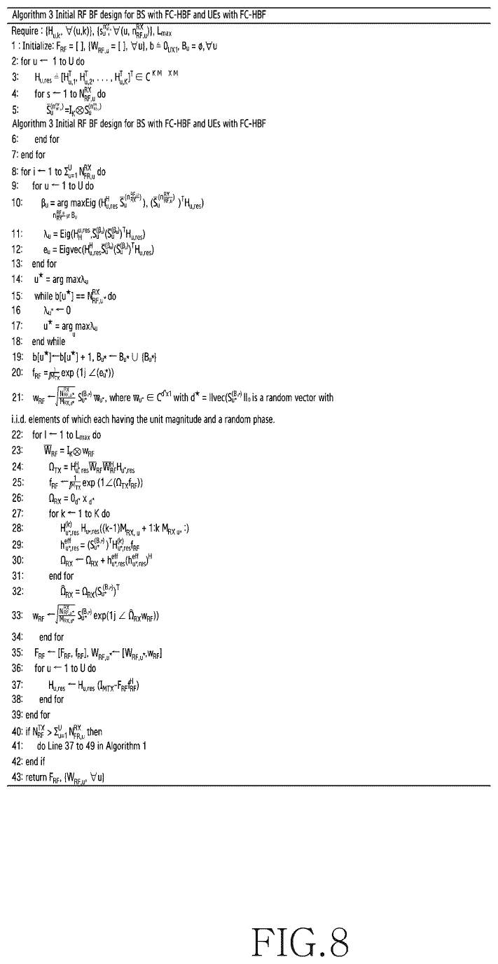

FIG. 8 illustrates an example initial RF BF design algorithm for hybrid beamforming design according to an embodiment of the disclosure. FIG. 8 illustrates an algorithm representing an initial RF BF design method under the conditions of the FC-HBF base station and PC-HBF users. FIG. 8 may correspond to 312 of FIG. 3, 2210 of FIG. 22, or 2310 of FIG. 23, and the algorithm may be performed by the user of FIG. 25 or the processor of the base station of FIG. 26.

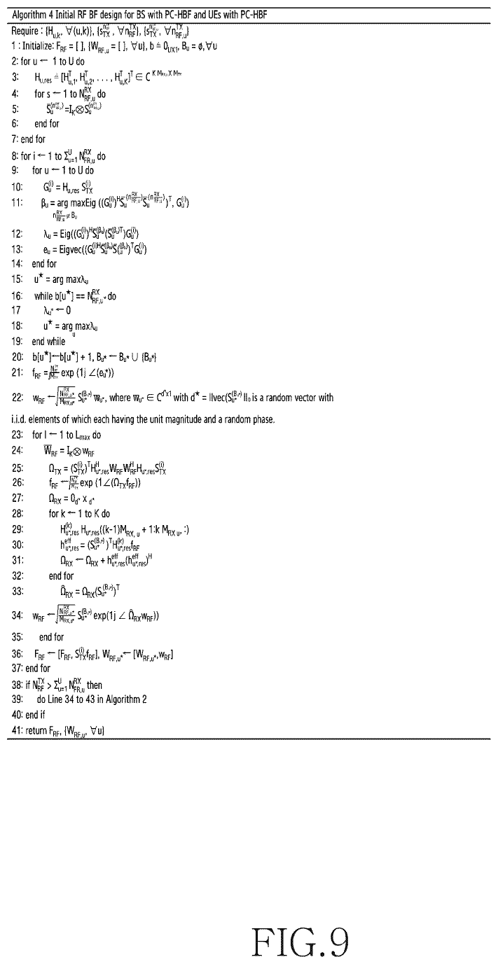

FIG. 9 illustrates an example initial RF BF design algorithm for hybrid beamforming design according to an embodiment of the disclosure. FIG. 9 illustrates an algorithm representing an initial RF BF design method under the conditions of the PC-HBF base station and PC-HBF users. FIG. 9 may correspond to 312 of FIG. 3, 2210 of FIG. 22, or 2310 of FIG. 23, and the algorithm may be performed by the user of FIG. 25 or the processor of the base station of FIG. 26.

In FIGS. 6 to 9, an initial RF BF design method according to an embodiment forms a number of RF beam pairs equal to the total number of RF chains of users (lines 5 to 35 in FIG. 6, lines 5 to 32 in FIG. 7, lines 5 to 39 in FIG. 8, and lines 5 to 37 in FIG. 9), and if there are remaining RF chains in the base station, the RF BF is designed under the assumption that the users have a virtual additional RF chain having an FC-PSN structure. The RF BF vector including the users' virtual RF chains is not included in the result of the algorithm.

In the operation of forming a beam pair, the user having the largest eigenvalue of a sum of the Gramian matrix of a residual channel per subcarrier is selected as the RF BF target to be designed in the future. In addition, the phase of the eigenvector having the corresponding eigenvalue is used as the initial BF vector phase in the base station RF beam algorithm (lines 6 to 16 in FIG. 6, lines 6 to 16 in FIG. 7, lines 6 to 20 in FIG. 8, and lines 6 to 21 in FIG. 9). In the algorithm illustrated in FIGS. 6 to 9, the function Eig(⋅) is a function for returning the largest eigenvalue and the function Eigvec(⋅) is a function for returning the principle eigenvector having the largest eigenvalue.

However, if the number of users equal to the number of RF chains owned by an already-formed RF beam is selected again in the process, a next-ranked user may be selected.

In the case of a PC-HBF base station, the connection matrix

$${S}_{TX}^{( {n}_{RF}^{TX} )} ∈ {ℝ}_{+}^{{M}_{TX} \times \vert {TX}_{( {n}_{RF}^{TX} )}^{} \vert}$$

between the RF chain and the antenna elements is considered in order to consider only the channels of the antenna elements connected to the RF chain that is the design target of the RF beam. When the number of the base station's RF chains is 2 and the number of antenna elements is 4 in a system, if the first RF chain is connected to the first and third antenna elements,

$${S}_{TX}^{( {n}_{RF}^{TX} )}$$

is as follows.

$${S}_{TX}^{( {n}_{RF}^{TX} )} = \{ \begin{matrix}[ \begin{matrix}1 & 0 \\ 0 & 0 \\ 0 & 1 \\ 0 & 0\end{matrix} ] , if {n}_{RF}^{TX} = 1 , \\ [ \begin{matrix}0 & 0 \\ 1 & 0 \\ 0 & 0 \\ 0 & 1\end{matrix} ] , otherwise\end{matrix} . \qquad ( 16 )$$

In the right side of equation (16), the row of the matrix indicates the antenna element, and the column indicates the phase shifter connected to the RF chain. Therefore, in equation (16),

$${S}_{TX}^{( 1 )} = [ \begin{matrix}1 & 0 \\ 0 & 0 \\ 0 & 1 \\ 0 & 0\end{matrix} ]$$

indicates that the base station's RF chain is connected to two antennas by two phase shifters. The first phase shifter is connected to the first antenna element and the second phase shifter is connected to the third antenna element.

In the case of PC-HBF users, the connection matrix

$${S}_{u}^{( {n}_{RF , u}^{RX} )}$$

between the RF chain and antenna elements is considered to only consider the channels with the reception antennas connected to each RF chain. Each RF chain of the same user is a different beam pair candidate. The meaning of the elements in matrix is

$${S}_{u}^{( {n}_{RF , u}^{RX} )}$$

similar to the meaning of the elements in

$${S}_{BS}^{( {n}_{RF}^{TX} )} ,$$

except that the body changes from the base station to the user u.

In the process of beam formation for each beam pair, the RF BF vector for the first-received RF beam is a random vector satisfying a constraint, and the transmission RF beamforming vector and the reception RF beamforming vector are designed through a power iteration method to have a high correlation with the Gramian matrix of the residual channel through iteration (the element-wise normalization of the RF BF vector is performed for each operation to satisfy the RF BF constraint).

The RF BF matrix may be designed by sequentially adding the RF BF vector designed through an iterated process (corresponding to lines 18 to 30 in FIG. 6, lines 18 to 30 in FIG. 7, lines 22 to 35 in FIG. 8, and lines 23 to 36 in FIG. 9). In addition, the residual channel is updated so that a part orthogonally projected to the space spanned by the RF beam designed to be almost orthogonal to the RF beam to be designed later is removed. However, in the case of the PC-HBF structure, since the space formed by the RF beam is already orthogonal to the later RF beam design space, the orthogonal projection process may be omitted (corresponding to lines 31 to 34 in FIG. 6, line 31 in FIG. 7, and lines 36 to 38 in FIG. 8).

The method for designing initial RF BF described in FIGS. 6 to 9 includes a process for forming a pair of the RF beam of the base station and the RF beam of the user. If the number of RF chains of the base station is greater than the total number of RF chains of the users, an additional transmission RF beam may be formed and an RF BF design for the additional transmission RF beam formation is as follows.

If the base station includes a spare RF chain, the users are assumed to have sufficiently many additional virtual RF chains, and a beam pair is formed. However, since the virtual additional RF BF vectors designed for the user are not actually used, it may be assumed that the additional RF BFs have a fully connected PSN regardless of the original user's PSN structure, and the number of beam formations per user may be limited in order to prevent and/or reduce an excessive design of the additional RF BFs for a single user.

In the case of additional RF BF design, since the user's PSN structure is assumed to be an FC PSN, the design algorithm is different due to the base station's HBF structure. Lines 36 to 50 in FIG. 6 indicate an additional RF BF design process in the FC-HBF base station, and lines 33 to 44 in FIG. 7 indicate an additional RF BF design process in the PC-HBF base station. FIGS. 8 and 9 perform the same process as FIGS. 6 and 7, respectively.

In an additional RF BF design process, the user having the largest eigenvalue of a sum of the Gramian matrix of a residual channel may be selected in a similar method to forming RF beam pairs as many as the number of user's RF chains (line 39 in FIG. 6 and line 36 in FIG. 7). In order to prevent and/or reduce excessive design of additional RF BFs for a single user, the number of additional RF BF vectors designed for a single user may be limited. For the algorithms of FIGS. 6 and 7, the number of additional RF BF vectors per user is represented by a ceiling value obtained by dividing the number of extra RF chains the base station has by the total number of users (lines 40 to 43 in FIG. 6 and lines 37 to 40 in FIG. 7).

A vector having a phase value of the principle eigenvector and satisfying a constraint of an RF BF vector may be defined as an initial RF BF vector, and the RF BF vectors may be designed in a power iteration method (lines 44 to 45 in FIG. 6 and lines 41 to 42 in FIG. 7). However, since the corresponding RF BF vectors are not actually used in the user, the process of orthogonally projecting the residual channel to the space spanned by the newly formed RF BF vector is not performed.

On the other hand, if the number of the base station's RF chains is smaller than the sum of the RF chains of the users

$$( e . g . , if {N}_{RF}^{TX} < {\sum }_{u = 1}^{U} {N}_{RF , u}^{RX} ) ,$$

the base station may be assumed to have

$${\sum }_{u = 1}^{U} {N}_{RF , u}^{RX} - {N}_{RF}^{TX}$$

additional RF chains for a total of

$${\sum }_{u = 1}^{U} {N}_{RF , u}^{RX}$$

RF chains, and the design may be performed based on the algorithms of FIGS. 6 and 8. However, an RF beam for an additional RF chain is not actually used.

Hereinafter, a baseband (BB) BF design method for hybrid beamforming design according to an embodiment of the disclosure will be described.

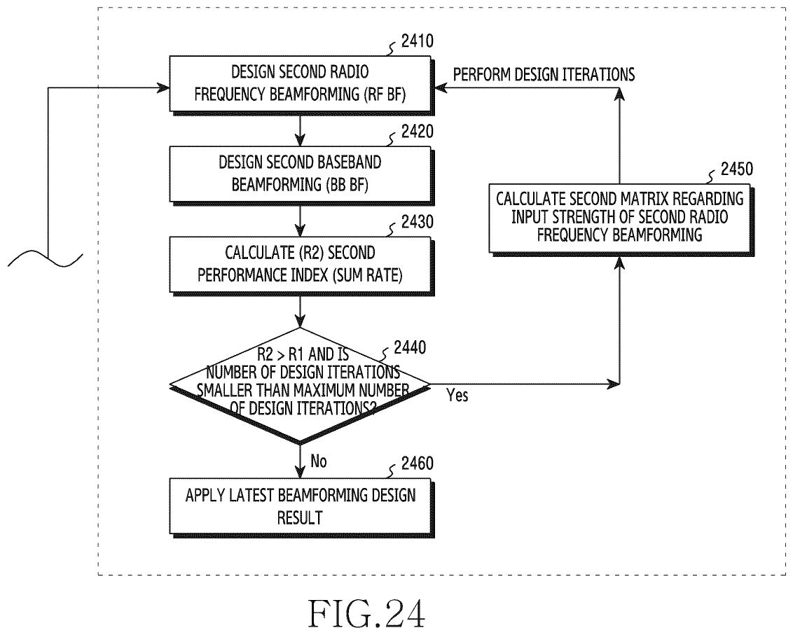

The BB BF design method according to an embodiment may correspond to 314 or 324 of FIGS. 3 and 1814 or 1824 of FIG. 18. In addition, the same may correspond to 2220 of FIG. 22, 2320 of FIG. 23, or 2420 of FIG. 24. In addition, the BB BF design method according to an embodiment may be performed by the user of FIG. 25 or the processor of the base station of FIG. 26.

The baseband (BB) BF design method according to an embodiment may consider the channel that is the product of the designed radio channel and the RF BFs as an effective channel or equivalent baseband channel, and may design the BB BF according to the FD BF design method. The input-output relationship expressed using the equivalent BB channel

$$\{ {H}_{eff , u , k} = {W}_{RF , u}^{H} {H}_{u , k} {F}_{RF} , ∀ ( u , k ) \}$$

and RF filtered noise

$$\{ {n}_{eff , u , k} = {W}_{RF , u}^{H} {n}_{u , k} , ∀ ( u , k ) \}$$

is as follows.

$${y}_{u , k} = {W}_{BB , u , k}^{H} {H}_{eff , u , k} {F}_{BB , u , k} {s}_{u , k} + {W}_{BB , u , k}^{H} {H}_{eff , u , k} {\sum }_{{u}^{′} \neq u} {F}_{BB , {u}^{′} , k} {s}_{{u}^{′} , k} + {W}_{BB , u , k}^{H} {n}_{eff , u , k} , ∀ ( u , k ) . \qquad ( 17 )$$

The FD BF design method according to an embodiment is listed below.

However, the BB BF design method according to an embodiment is not limited to the FD BF design method listed below, and other methods may be used.
1) Block-diagonalization (BD)
2) Regularized BD (RBD) or Regularized channel diagonalization (RCD)
3) SLNR maximizing BF
4) MMSE BF
5) WMMSE BF

Hereinafter, FD BF design methods according to an embodiment will be described.

1) BB BF design method using BD

The transmission baseband BF using BD has a structure F_{BB,u,k}=G_{BD,u,k}G_{SU,u,k}.

First,

$${\overline{H}}_{u , k} = {[ {H}_{eff , 1 , k}^{T} , … , {H}_{eff , u - 1 , k}^{T} , {H}_{eff , u + 1 , k}^{T} , … , {H}_{eff , U , k}^{T} ]}^{T}$$

is defined to design G_{BD,u,k}. The SVD of H̅_{u,k} is

$${\overline{H}}_{u , k} = {\overline{U}}_{u , k} {\overline{\sum }}_{u , k} {\overline{V}}_{u , k}^{H} , and {\overline{V}}_{u , k}^{null} in {\overline{V}}_{u , k} {=}^{Δ} [ {\overline{V}}_{u , k}^{sig} , {\overline{V}}_{u , k}^{null} ]$$

is a semi-unitary matrix of right-singular vectors with singular values equal to 0.

Therefore, it is designed with

$${G}_{BD , u , k} = {\overline{V}}_{u , k}^{null}$$

to satisfy H_{eff,u′≠u,k}G_{BD,u,k}=0.

In addition, G_{SU,u,k} and W_{BB,u,k} are designed based on the right and left singular vectors of H_{eff,u,k}G_{BD,u,k}, and the corresponding singular vectors have the largest singular value of L_{u,k}. Therefore,

$${G}_{SU , u , k} = {V}_{u , k} ( {:}_{,} 1 : {L}_{u , k} ) {P}_{u , k}^{\frac{1}{2}}$$

and W_{BB,u,k}=U_{u,k}(:,1:L_{u,k}), and

$${P}_{u , k}^{\frac{1}{2}}$$

is a power allocation matrix that may be designed by a water-filling algorithm.

In summary, the BD-based BB BF design is as follows.

$${F}_{BB , u , k} = {\overline{V}}_{u , k}^{null} {V}_{u , k} ( : , 1 : {L}_{u , k} ) {P}_{u , k}^{\frac{1}{2}} , {W}_{BB , u , k} = {U}_{u , k} ( : , 1 : {L}_{u , k} ) . \qquad ( 18 )$$

### 2) BB BF Design Method Using RBD

The transmission BB BF in the RBD is F_{BB,u,k}=βG_{RBD,u,k}G_{SU,u,k} and β is a normalization term to satisfy the total transmission power limit considering the RF BF effect. G_{RBD,u,k} is designed to minimize the leakage-plus-noise value and may be designed as follows.

$${G}_{RBD , u , k} = \{ \begin{matrix}{{\overline{V}}_{u , k} ( {\overline{\sum }}_{u , k}^{T} {\overline{\sum }}_{u , k} + \frac{{\sum }_{u = 1}^{U} {σ}_{n}^{2} {‖ {W}_{RF , u}^{H} ‖}_{F}^{2}}{{P}_{BS}} {I}_{{M}_{TX}} )}^{- \frac{1}{2}} , if the BS has FC ‐ HBF , \\ {{\overline{V}}_{u , k} ( {\overline{\sum }}_{u , k}^{T} {\overline{\sum }}_{u , k} + \frac{{\sum }_{u = 1}^{U} {σ}_{n}^{2} {‖ {W}_{RF , u}^{H} ‖}_{F}^{2}}{{P}_{BS} / {N}_{RF}^{TX}} {I}_{{M}_{TX}} )}^{- \frac{1}{2}} , if the BS has PC ‐ HBF .\end{matrix} \qquad ( 19 )$$

$${G}_{SU , u , k} = {V}_{u , k} ( : , 1 : {L}_{u , k} ) {P}_{u , k}^{\frac{1}{2}} and {W}_{B B , u , k} = {U}_{u , k} ( : , 1 : {L}_{u , k} ) {P}_{u , k}^{\frac{1}{2}}$$

represent power allocation matrices according to the optimization conditions through the SVD

$${H}_{eff , u , k} {G}_{RBD , u , k} = {U}_{u , k} {\sum }_{u , k} {V}_{u , k}^{H}$$

of the matrix that multiplies the channel matrix by the normalization term β to satisfy the designed G_{RBD,u,k} and the total transmission power limit.

Therefore, the design of the baseband BF using the RBD is as follows.

$${\{ {F \text{}}_{BB , u , k} = \begin{matrix}\{ \begin{matrix}β {{\overline{V}}_{u , k} ( {\overline{\sum }}_{u , k}^{T} {\overline{\sum }}_{u , k} + \frac{{\sum }_{u = 1}^{U} {σ}_{n}^{2} {‖ {W}_{R , F , u}^{H} ‖}_{F}^{2}}{{P}_{BS}} {I}_{{M}_{TX}} )}^{- 1} {V}_{u , k} ( : , 1 : {L}_{u , k} ) {P}_{u , k}^{\frac{1}{2}} , if the BS has FC ‐ H \text{?} \\ β {{\overline{V}}_{u , k} ( {\overline{\sum }}_{u , k}^{T} {\overline{\sum }}_{u , k} + \frac{{\sum }_{u = 1}^{U} {σ}_{n}^{2} {‖ {W}_{RF , u}^{H} ‖}_{F}^{2}}{{P}_{BS} / {N}_{RF}^{TX}} {I}_{{M}_{TX}} )}^{- 1} {V}_{u , k} ( : , 1 : {L}_{u , k} ) {P}_{u , k}^{\frac{1}{2}} , if the BS has PC ‐ H \text{?}\end{matrix} \\ {W \text{}}_{BB , u , k} = {U}_{u , k} ( : , 1 : {L}_{u , k} )\end{matrix}}_{}$$

$$\text{?} \text{indicates text missing or illegible when filed}$$

### 3) BB BF Design Method Using RCD

The transmission BB BF in the RCD is F_{BB,u,k}=βG_{RCD,u,k}G_{SU,u,k}, and β is a normalization term to satisfy the total transmission power limit considering the total RF BF effects.

In RBD, since G_{RBD,u,k} is actually a weighted eigenvector of

$${( {\overline{H}}_{u , k}^{H} {\overline{H}}_{u , k} + \frac{{\sum }_{u = 1}^{U} {σ}_{n}^{2} {‖ {W}_{R , F , u}^{H} ‖}_{F}^{2}}{{P}_{BS}} {I}_{{M}_{TX}} )}^{- 1} or$$

$${( {\overline{H}}_{u , k}^{H} {\overline{H}}_{u , k} + \frac{{\sum }_{u = 1}^{U} {σ}_{n}^{2} {‖ {W}_{R , F , u}^{H} ‖}_{F}^{2}}{{P}_{BS} / {N}_{RF}^{TX}} {I}_{{M}_{TX}} )}^{- 1} ,$$

G_{RCD,u,k} is designed as follows without performing eigenvalue decomposition (EVD).

$${G}_{R CD , u , k} = \{ \begin{matrix}{( {\overline{H}}_{u , k}^{H} {\overline{H}}_{u , k} + \frac{{\sum }_{u = 1}^{U} {σ}_{n}^{2} {‖ {W}_{R , F , u}^{H} ‖}_{F}^{2}}{{P}_{BS}} {I}_{{M}_{TX}} )}^{- 1} , if the BS has FC ‐ HBF , \\ {( {\overline{H}}_{u , k}^{H} {\overline{H}}_{u , k} + \frac{{\sum }_{u = 1}^{U} {σ}_{n}^{2} {‖ {W}_{R , F , u}^{H} ‖}_{F}^{2}}{{P}_{BS} / {N}_{RF}^{TX}} {I}_{{M}_{TX}} )}^{- 1} , if the BS has PC ‐ HBF .\end{matrix} \qquad ( 21 )$$

When the SVD of matrix H_{eff,u,k}G_{RCD,u,k} is

$${H}_{eff , u , k} {G}_{RCD , u , k} = {U}_{u , k} {\sum }_{u , k} {V}_{u , k}^{H} , {G}_{SU , u , k} = {V}_{u , k} ( : , 1 : {L}_{u , k} ) {Γ}_{u , k}^{\frac{1}{2}}$$

and W_{BB,u,k}=U_{u,k}(:,1:L_{u,k}), and

$${Γ}_{u , k}^{\frac{1}{2}}$$

is a normalization matrix to adjust the norm of all columns of G_{RCD,u,k}V_{u,k}(:,1:L_{u,k}) to 1.

Therefore, the BB BF design using RCD is as follows.

$${\{ {F \text{}}_{BB , u , k} = \begin{matrix}\{ \begin{matrix}β {( {\overline{H}}_{u , k}^{H} {\overline{H}}_{u , k} + \frac{{\sum }_{u = 1}^{U} {σ}_{n}^{2} {‖ {W}_{RF , u}^{H} ‖}_{F}^{2}}{{P}_{BS}} {I}_{{M}_{TX}} )}^{- 1} {V}_{u , k} ( : , 1 : {L}_{u , k} ) {Γ}_{u , k}^{\frac{1}{2}} , if the BS has FC ‐ HBF , \\ β {( {\overline{H}}_{u , k}^{H} {\overline{H}}_{u , k} + \frac{{\sum }_{u = 1}^{U} {σ}_{n}^{2} {‖ {W}_{RF , u}^{H} ‖}_{F}^{2}}{{P}_{BS} / {N}_{RF}^{TX}} {I}_{{M}_{TX}} )}^{- 1} {V}_{u , k} ( : , 1 : {L}_{u , k} ) {Γ}_{u , k}^{\frac{1}{2}} , if the BS has PC ‐ HBF\end{matrix} \\ {W \text{}}_{BB , u , k} = {U}_{u , k} ( : , 1 : {L}_{u , k} ) .\end{matrix}}_{}$$

### 4) BB BF Design Method Using SLNR Maximizing BF

According to the input-output relationship in a given RF BF environment, the SLNR value of the kₜₕ subcarrier data of the uₜₕ user is expressed as follows.

$${SLNR}_{u , k} = \{ \begin{matrix}\frac{{H}_{eff , u , k}^{H} {H}_{eff , u , k}}{TR [ {\overline{H}}_{u , k}^{H} {\overline{H}}_{u , k} + \frac{{σ}_{n}^{2} {‖ {W}_{RF , u}^{H} ‖}_{F}^{2}}{{P}_{BS} / U} {I}_{{M}_{TX}}} , if the BS has FC ‐ HBF \\ \frac{{H}_{eff , u , k}^{H} {H}_{eff , u , k}}{TR [ {\overline{H}}_{u , k}^{H} {\overline{H}}_{u , k} + \frac{{σ}_{n}^{2} {‖ {W}_{RF , u}^{H} ‖}_{F}^{2}}{{P}_{BS} / {UN}_{RF}^{TX}} {I}_{{M}_{TX}}} , if the BS has PC ‐ HBF .\end{matrix} \qquad ( 23 )$$

Therefore, since the transmission BB BF is designed with the generalized eigenvectors of the numerator and denominator of the SLNR representation, the transmission BB BF may be expressed as follows.

$${F}_{BB , u , k} = \{ \begin{matrix}\{ \begin{matrix}β Eig \{ \begin{matrix}{H}_{eff , u , k}^{H} {H}_{eff , u , k} {\overline{H}}_{u , k}^{H} {\overline{H}}_{u , k} + \\ \frac{{σ}_{n}^{2} {‖ {W}_{RF , u}^{H} ‖}_{F}^{2}}{{P}_{BS} / U} {I}_{{M}_{TX}}\end{matrix} \} , \\ if the BS has FC ‐ H B F\end{matrix} \\ \{ \begin{matrix}β Eig \{ \begin{matrix}{H}_{eff , u , k}^{H} {H}_{eff , u , k} {\overline{H}}_{u , k}^{H} {\overline{H}}_{u , k} + \\ \frac{{σ}_{n}^{2} {‖ {W}_{RF , u}^{H} ‖}_{F}^{2}}{{P}_{BS} / {UN}_{RF}^{TX}} {I}_{{M}_{TX}}\end{matrix} \} , \\ if the BS has PC ‐ HBF .\end{matrix}\end{matrix} \qquad ( 24 )$$

The reception BB BF W_{BB,u,k} in the user may be designed by considering the product of H_{eff,u,k} and {F_{BB,u,k}, ∀k} as the final radio channel during the design process and designing a linear MMSE combining BF.

### 5) BB BF Design Method Using MMSE BF

The transmission baseband beamforming in MMSE BF is F_{BB,u,k}=βG_{MMSE,u,k}G_{SU,u,k}, and G_{MMSE,u,k} is as follows.

$${G}_{MMSE , u , k} = \{ \begin{matrix}{( \begin{matrix}{H}_{eff , k}^{H} {H}_{eff , k} + \\ \frac{{\sum }_{u = 1}^{U} {σ}_{n}^{2} {‖ {W}_{RF , u}^{H} ‖}_{F}^{2}}{{P}_{BS}} {I}_{{M}_{TX}}\end{matrix} )}^{- 1} {H}_{eff , u , k} , \\ if the BS has FC ‐ HBF \\ {( \begin{matrix}{H}_{eff , k}^{H} {H}_{eff , k} + \\ \frac{{\sum }_{u = 1}^{U} {σ}_{n}^{2} {‖ {W}_{RF , u}^{H} ‖}_{F}^{2}}{{P}_{BS} / {N}_{RF}^{TX}} {I}_{{M}_{TX}}\end{matrix} )}^{- 1} {H}_{eff , u , k} , \\ if the BS has PC ‐ HBF .\end{matrix} \qquad equation ( 25 )$$

$$In equation ( 25 ) , {H}_{eff , k}^{H} = {[ {H}_{eff , 1 , k}^{H} {H}_{eff , 2 , k} , … , {H}_{eff , U , k}^{T} ]}^{T} .$$

When the SVD of matrix H_{eff,u,k}G_{MMSE,u,k} is

$${H}_{eff , u , k} {G}_{MMSE , u , k} = {U}_{u , k} {\sum }_{u , k} {V}_{u , k}^{H} , {G}_{SU , u , k} = {V}_{u , k} ( : , 1 : {L}_{u , k} ) {Γ}_{u , k}^{\frac{1}{2}}$$

and W_{BB,u,k}=U_{u,k}(:,1:L_{u,k}), and

$${Γ}_{u , k}^{\frac{1}{2}}$$

is a normalization matrix to adjust the norm of all columns of G_{MMSE,u,k}V_{u,k}(:,1:L_{u,k}) to 1.

In summary, the BB BF design through MMSE BF is as follows.

$$\{ {F}_{BB , u , k} = \{ \begin{matrix}\{ β {\{ \begin{matrix}{H}_{eff , k}^{H} {H}_{eff , k} + \\ \frac{{\sum }_{u = 1}^{U} {σ}_{n}^{2} {‖ {W}_{RF , u}^{H} ‖}_{F}^{2}}{{P}_{BS}} {I}_{{M}_{TX}}\end{matrix} \}}^{- 1} {H}_{eff , u , k}^{H} {V}_{u , k} ( : , 1 : {L}_{u , k} ) {Γ}_{u , k}^{\frac{1}{2}} , \\ if the BS has FC \text{?} \\ \{ β {\{ \begin{matrix}{H}_{eff , k}^{H} {H}_{eff , k} + \\ \frac{{\sum }_{u = 1}^{U} {σ}_{n}^{2} {‖ {W}_{RF , u}^{H} ‖}_{F}^{2}}{{P}_{BS} / {N}_{RF}^{TX}} {I}_{{M}_{TX}}\end{matrix} \}}^{- 1} {H}_{eff , u , k}^{H} {V}_{u , k} ( : , 1 : {L}_{u , k} ) {Γ}_{u , k}^{\frac{1}{2}} , \\ if the BS has PC \text{?}\end{matrix}$$

$${W}_{BB , u , k} = {U}_{u , k} ( : , 1 : {L}_{u , k} )$$

$$\text{?} \text{indicates text missing or illegible when filed}$$

Hereinafter, an RF BF design method considering BB BF according to an embodiment of the disclosure will be described.

The RF BF design method considering BB BF according to an embodiment may correspond to 322 of FIG. 3, 1822 of FIG. 18, 2210 of FIG. 22, or 2410 of FIG. 24. The RF BF design method considering BB BF according to an embodiment may be performed by the user of FIG. 25 or the base station of FIG. 26.

A hybrid beamforming design method according to an embodiment of the disclosure considers the influence of the BB BF in an RF BF design process for performance optimization. A design method according to an embodiment considers an RF chain as a virtual antenna, and views an existing downlink system as a downlink system in an RF-to-RF viewpoint (or equivalent baseband viewpoint).

In this case, the output signal of the BB BF is equivalent to the input signal of the RF chain. From the RF-to-RF perspective, the covariance matrix of the output signal of BB BF may be viewed as playing a role of the covariance matrix of the input signal in an existing MIMO system. Therefore, the problem of maximizing the achievable sum rate through the RF-to-RF channel may be described as a problem of optimizing the beamforming when the covariance matrix of the input signal is given.

Assuming that the reception antennas of users are recognized as remote antennas of a single virtual user and that user-to-user interference may be eliminated through cooperative data detection between users, the sum rate achievable by an RF-to-RF channel (or equivalent BB channel) may be expressed as follows.

$${R}^{RF} = \frac{{ρ}^{′}}{K} {\sum }_{k = 1}^{K} {log}_{2} \vert {I}_{{N}_{RF}^{TX}} + \frac{1}{{σ}_{n}^{2}} {( {P}_{RF , k} )}^{\frac{1}{2}} {F}_{RF}^{H} {H}_{k}^{H} {{W}_{RF} ( {W}_{RF}^{H} {W}_{RF} )}^{- 1} {W}_{RF}^{H} {H}_{k} {{F}_{RF} ( {P}_{RF , k} )}^{\frac{1}{2}} \vert \approx \frac{{ρ}^{′}}{K} {\sum }_{k = 1}^{K} {log}_{2} \vert {I}_{{N}_{RF}^{TX}} + \frac{1}{{σ}_{n}^{2}} {F}_{RF}^{H} {H}_{k}^{H} {W}_{RF} {W}_{RF}^{H} {H}_{k} {F}_{RF} {P}_{RFF , k} \vert , \qquad ( 27 )$$

In equation (27),

$${H}_{k} = {[ {H}_{1 , k}^{T} , {H}_{2 , k}^{T} , … , {H}_{U , k}^{T} ]}^{T}$$

and W_{RF}=Bdiag(W_{RF,1}, W_{RF,2}, . . . , W_{RF,U}), and

$${P}_{RF , k} ∈ {ℂ}^{{N}_{RD}^{TX} \times {N}_{RF}^{TX}}$$

is a matrix indicating the power of data passing through the BB BF of the kₜₕ subcarrier entering the RF chains. That is, P_{RF,k} is the output of the BB BF and the matrix related to the input of the RF BF.

In the approximation process of equation (27),

$${W}_{RF}^{H} {W}_{RF} \approx {I}_{{\sum }_{u = 1}^{U} {N}_{RF , u}^{RX}}$$

is reasonable when users have FC-HBF structures and the number of users or their number of antennas is large. In addition, if users have PC-HBF structures, the upper and lower equations on the right side in equation (27) are equivalent.

The upper bound of Equation (27) may be expressed as the right side of the equation below (the concavity of the logarithmic function, Jensen's inequality, and the property called |I+AB|=|I+BA| in linear algebra are used).

$${R}^{R F} \leq {ρ}^{′} {log}_{2} \vert {I}_{{\sum }_{u = 1}^{U} {N}_{RF , u}^{RX}} + \frac{1}{K {σ}_{n}^{2}} {W}_{RF}^{H} [ {\sum }_{k = 1}^{K} {H}_{k} {F}_{RF} {P}_{RF , k} {F}_{RF}^{H} {H}_{k}^{H} ] {W}_{RF} \vert {=}^{Δ} {\overline{R}}^{R F} . \qquad ( 28 )$$

The above equation (28) may be used as a metric to optimize users' RF BFs W_{RF} when F_{RF} and {P_{RF,K}, ∀k} are fixed. Therefore, when users use FC-HBF for given F_{RF} and {P_{RF,k}, ∀k}, W_{RF} design problem may be expressed as follows.

$${W}_{RF}^{opt} = {arg max {log}_{2}}_{{W}_{RF}} \vert {I}_{{\sum }_{u = 1}^{U} {N}_{RF , u}^{RX}} + \frac{1}{K {σ}_{n}^{2}} {W}_{RF}^{H} [ {\sum }_{k = 1}^{K} {H}_{k} {F}_{RF} {P}_{RF , k} {F}_{RF}^{H} {H}_{k}^{H} ] {W}_{RF} \vert , \qquad ( 29 )$$

$$where \vert {W}_{RF , u} ( {m}_{RX , u} , {n}_{RF , u}^{RX} ) \vert = \frac{1}{\sqrt{{M}_{RX , u}}} , ∀ ( {m}_{RX , u} , {n}_{RF , u}^{RX} ) .$$

In the case of the PC-HBF structure, the W_{RF} design problem may be expressed as follows.

$${W}_{RF}^{opt} = {arg max {log}_{2}}_{{W}_{RF}} \vert {I}_{{\sum }_{u = 1}^{U} {N}_{RF , u}^{RX}} + \frac{1}{K {σ}_{n}^{2}} {W}_{RF}^{H} [ {\sum }_{k = 1}^{K} {H}_{k} {F}_{RF} {P}_{RF , k} {F}_{RF}^{H} {H}_{k}^{H} ] {W}_{RF} \vert , \qquad ( 30 )$$

$$where \vert {W}_{RF , u} ( {m}_{RX , u} , {n}_{RF , u}^{RX} ) \vert = \{ \begin{matrix}\sqrt{\frac{{N}_{RF , u}^{RX}}{{m}_{RX , u}}} & if {m}_{RX , u} ϵ {u}_{( {n}_{RF , u}^{RX} )}^{} , \\ 0 & otherwise\end{matrix} .$$

The difference between equations (29) and (30) is the size limit of the RF BF matrix elements according to the users' HBF structure, and in equation (30),

$${u}_{( {n}_{RF , u}^{RX} )}^{}$$

is the index set of the reception antenna elements connected to the

$${n}_{RF , {u}^{th}}^{RX}$$

RF chain of user u and the phase shifter.

A design method according to an embodiment may be used to address the above problem by considering that the remaining columns are fixed in order from the first column of W_{RF}, and updating them in a direction that maximizes

$$\vert {I}_{{N}_{RF}^{TX}} + \frac{1}{K {σ}_{n}^{2}} {W}_{RF}^{H} [ {\sum }_{k = 1}^{K} {H}_{k} {F}_{RF} {P}_{RF} , {F}_{RF}^{H} {H}_{k}^{H} ] {W}_{R F} \vert .$$

In addition, in each column, the phase shift values may only be updated for locations where there is an actual phase shifter, in order from the first element of each column to the last element. In addition, since log₂|X| is an increasing function for a positive definite (PD) matrix X, a new upper bound (UB) may be obtained by adding any positive semi-definite (PSD) matrix to the matrix that is the determinant in the logarithm in equations (28), (29), and (30). For example, it is also conceivable to substitute P_{RF,K}+Ξₖ, which is the PSD matrix Ξₖ added to P_{RF,k}, instead of P_{RF,k}.

For equations (29) to (30), there exists a solution to update W_{RF} for the form of the right side in the equations. This may be used to derive an optimal W_{RF} (user's RF BF). As shown in equations (29) to (30), the right side includes P_{RF,k} term, which indicates the output (or the input of the RF BF) of the BB BF. Therefore, the user's RF BF may be updated in consideration of the output of the BB BF (or the input of the RF BF).

The RF BF design method according to an embodiment may consider the input power covariance of the RF chains together with channel information for all users and all SCs of the OFDM. In addition, since the target to be maximized is a function including the noise variance, the RF BF may be differently designed according to the noise variance.

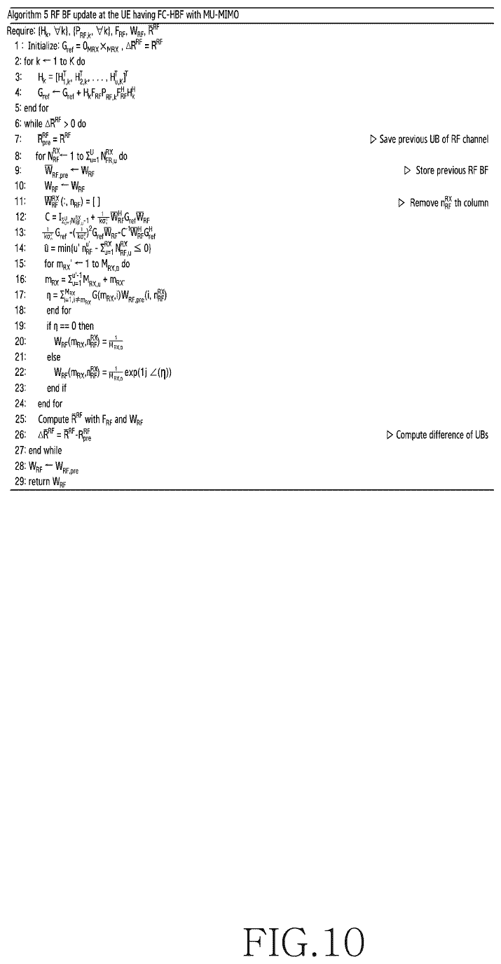

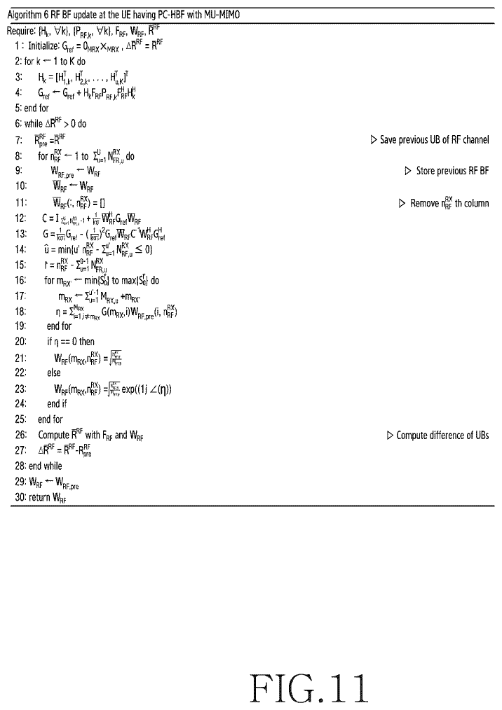

Based on equation (29) or equation (30), the algorithm for RF BF update of users having an FC-HBF structure or a PC-HBF structure is illustrated in FIGS. 10 and 11.

FIG. 10 is a diagram illustrating an example RF BF update algorithm for hybrid beamforming design according to various embodiments. FIG. 10 illustrates an example method of RF BF design of users having an FC-HBF structure.

The algorithm of FIG. 10 may correspond to the execution operation of operation 322 of FIG. 3, operation 1822 of FIG. 18, operation 2210 of FIG. 22, or operation 2410 of FIG. 24. In addition, the operation may be performed by the user of FIG. 25 or the base station of FIG. 26.

Referring to line 8 to line 24 of the algorithm, the RF BF is updated in sequence from the first column by the FOR statement. Line 9 stores the previously designed RF BF, and lines 10 and 11 store a matrix from which a column part to be designed is removed in order to consider only parts other than the column to be designed. Line 14 searches for which user's RF BF the current column to be designed belongs to and stores the index of the corresponding user as a variable u′. In addition, lines 15 to 18 are the process for phase shift design for each antenna of user u′, and line 16 determines the location of the designed phase shifter in the entire W_{RF}. Lines 19 to 23 are the process of updating the RF BF element, and the RF BF element may be determined according to the phase of calculated n in line 17.

FIG. 11 is a diagram illustrating an example RF BF update algorithm for hybrid beamforming design according to various embodiments. FIG. 11 illustrates an example method of RF BF design of users having PC-HBF structures.

The algorithm of FIG. 11 may correspond to the execution operation of operation 322 of FIG. 3, operation 1822 of FIG. 18, operation 2210 of FIG. 22, or operation 2410 of FIG. 24. In addition, the operation may be performed by the user of FIG. 25 or the base station of FIG. 26.

FIG. 11 includes a process for finding an RF chain index \hat{r} of a real user u′ corresponding to a column to be designed in line 15, and designing RF BF by performing a for statement only for the antenna index connected to the RF chain \hat{r} in line 16. In addition, lines 18 to 22 reflect different normalization factors due to the different element size limits of RF BF.

For the RF BF design of the base station according to an embodiment, the above-described equation (28) may be modified and expressed as follows.

$${R}^{R F} \leq {ρ}^{′} {log}_{2} \vert {I}_{{\sum }_{u = 1}^{U} {N}_{RF , u}^{RX}} + \frac{1}{K {σ}_{n}^{2}} {W}_{RF}^{H} [ {\sum }_{k = 1}^{K} {H}_{k} {F}_{RF} {P}_{RF , k} {F}_{RF}^{H} {H}_{k}^{H} ] {W}_{R F} \vert = {ρ}^{′} {log}_{2} \vert {I}_{{\sum }_{u = 1}^{U} {N}_{RF , u}^{RX}} + \frac{1}{K {σ}_{n}^{2}} {\sum }_{k = 1}^{K} {W}_{RF}^{H} {H}_{k} {F}_{RF} {{P}_{RF , k} ( {W}_{RF}^{H} {H}_{k} {F}_{RF} )}^{†} {W}_{RF}^{H} {H}_{k} {F}_{RF} {F}_{RF}^{H} {H}_{k}^{H} {W}_{RF} = {ρ}^{′} {log}_{2} \vert {I}_{{N}_{RF}^{TX}} + \frac{1}{K {σ}_{n}^{2}} {F}_{RF}^{H} [ {\sum }_{k = 1}^{K} {H}_{k}^{H} {W}_{RF} {H}_{RF , k} {{P}_{RF , k} ( {H}_{RF , k} )}^{†} {W}_{RF}^{H} {H}_{k} ] {F}_{RF} \vert = {ρ}^{′} {log}_{2} \vert {I}_{{N}_{RF}^{TX}} + \frac{1}{K {σ}_{n}^{2}} {F}_{RF}^{H} [ {\sum }_{k = 1}^{K} {H}_{k}^{H} {W}_{RF} {\hat{P}}_{RF , k} {W}_{RF}^{H} {H}_{k} ] {F}_{RF} \vert {=}^{Δ} {\overline{R}}^{RF} . \qquad ( 31 )$$

Referring, to equation (31),

$${H}_{RF , k} = {W}_{RF}^{H} {H}_{k} {F}_{RF and}$$

$${\hat{P}}_{RF , k} = {( {H}_{RF , k} {H}_{RF , k}^{H} )}^{- \frac{H}{2}} {H}_{RF , k} {P}_{RF , k} {{H}_{RF , k}^{H} ( {H}_{RF , k} {H}_{RF , k}^{H} )}^{- \frac{1}{2}} ,$$

and for any matrix A, A^{†} may represent the pseudo-inverse of matrix A. The base station RF beamforming design method may differ based on the base station's PSN structure. In a case where the base station has an FC-HBF structure, a problem for RF BF design may be expressed as follows.

$${F}_{RF}^{opt} = {arg max {log}_{2}}_{{F}_{RF}} \vert {I}_{{N}_{RF}^{TX}} + \frac{1}{K {σ}_{n}^{2}} {F}_{RF}^{H} [ {\sum }_{k = 1}^{K} {H}_{k}^{H} {W}_{RF} {\hat{P}}_{RF , k} {W}_{RF}^{H} {H}_{k} ] {F}_{RF} \vert , \qquad ( 32 )$$

$$where \vert {F}_{RF} ( {m}_{TX} , {n}_{RF}^{TX} ) \vert = \frac{1}{\sqrt{{M}_{TX}}} , ∀ ( {m}_{TX} , {n}_{RF}^{TX} ) .$$

Equation (32) may be updated in a direction of maximizing the objective function in order from the first column, in a method similar to the user's RF BF design.

In addition, a problem for the RF BF design of the base station having a PC-HBF structure may be expressed as follows.

$${F}_{RF}^{opt} = {arg max {log}_{2}}_{{F}_{RF}} \vert {I}_{{N}_{RF}^{TX}} + \frac{1}{K {σ}_{n}^{2}} {F}_{RF}^{H} [ {\sum }_{k = 1}^{K} {H}_{k}^{H} {W}_{RF} {\hat{P}}_{RF , k} {W}_{RF}^{H} {H}_{k} ] {F}_{RF} \vert , \qquad ( 33 )$$

$$where \vert {F}_{RF} ( {m}_{T X} , {n}_{RF}^{TX} ) \vert = \{ \begin{matrix}\sqrt{\frac{{N}_{RF}^{TX}}{{M}_{TX}} ,} & if {m}_{TX} ∈ {TX}_{( {n}_{RF}^{TX} )}^{} , \\ 0 , & otherwise\end{matrix} .$$

For equations (32) to (33), there exists a solution to update F_{RF} for the form of the right side in the equations. This may be used to derive an optimal F_{RF} (base station's RF BF). As shown in equations (32) to (33), the right side includes \hat{P}_{RF,k} term, which is a matrix related to the output (or the input of the RF BF) of the BB BF (because it is a term derived based on the aforementioned P_{RF,k}). That is, the base station's RF BF is updated in consideration of the output of the BB BF (or the input of the RF BF).

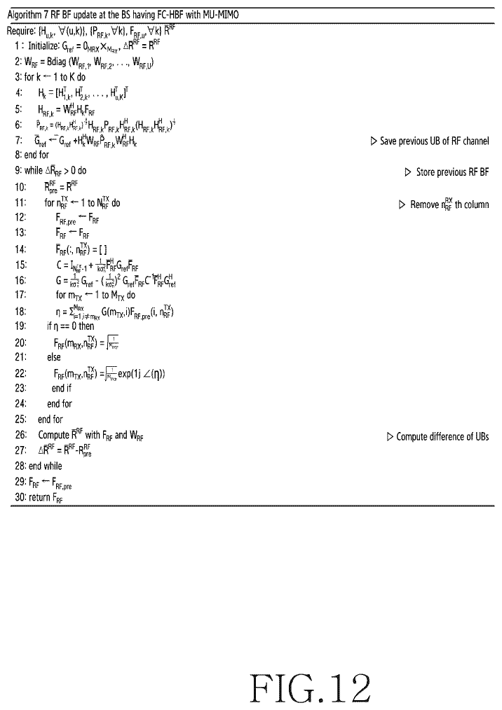

FIG. 12 is a diagram illustrating an example RF BF update algorithm for hybrid beamforming design according to various embodiments. FIG. 12 illustrates an example method of RF BF update of the base station having an FC-HBF structure. The algorithm of FIG. 12 may correspond to the execution operation of operation 322 of FIG. 3, operation 1822 of FIG. 18, operation 2210 of FIG. 22, or operation 2410 of FIG. 24. In addition, the operation may be performed by the user of FIG. 25 or the base station of FIG. 26.

Lines 11 to 25 update the RF BF from the first column onward. Line 12 stores the previously designed RF BF, and lines 13 and 14 store a matrix from which a column part to be designed is removed in order to consider only parts other than the column to be designed. Lines 17 to 25 are the process of updating the RF BF element, and the RF BF element may be determined according to the phase of calculated n in line 18.

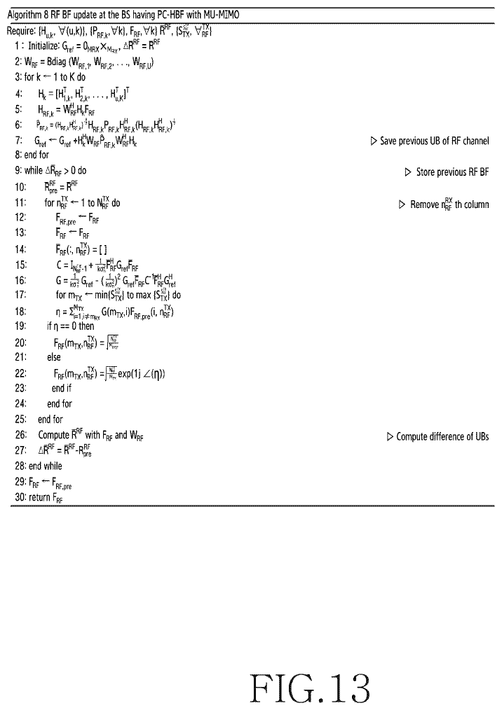

FIG. 13 is a diagram illustrating an example RF BF update algorithm for hybrid beamforming design according to various embodiments. FIG. 13 illustrates an example method of RF BF design of the base station having a PC-HBF structure.

The algorithm of FIG. 13 may correspond to the execution operation of operation 322 of FIG. 3, operation 1822 of FIG. 18, operation 2210 of FIG. 22, or operation 2410 of FIG. 24. In addition, the operation may be performed by the user of FIG. 25 or the base station of FIG. 26.

FIG. 13 designs RF BF by performing a for statement only for the antenna index connected to the design target RF chain in line 17. In addition, lines 19 to 23 reflect different normalization factors due to the different element size limits of RF BF.

The hybrid beamforming design method according to an embodiment may update the HBF depending on whether the performance is improved. In the algorithms of FIGS. 10 to 13, the condition of the while statement (line 6 of FIGS. 10 and 11 and line 9 of FIGS. 12 and 13) may be changed to whether the absolute value of ΔR̅^{RF} exists within a specific range. For example, the conditional statement may be changed to while |ΔR̅^{RF}|>ϵ for any small positive number ϵ.

If a performance index achievable based on the newly designed RF BF and BB BF is not improved over the previously designed result or the maximum number of design iterations has been reached, the design may be stopped and information may be transmitted and received based on the most recently designed result (recently stored result).

If the performance index (e.g., sum rate) is improved based on newly designed RF BF and BB BF, it may be determined that there is room for improvement and the design process may be iterated. When newly designing RF BF, an input power of an RF chain according to a previous BB BF result may be considered.

For example, in the operation of re-designing the RF BF, the input power of the RF chain may be considered to reflect the influence of the baseband (BB) BF.

The hybrid beamforming design method according to an embodiment may consider RF chains of the base station and users as virtual antennas, and design RF BF in a direction that maximizes the upper bound (UB) of the total transmission rate by considering the input signal power of the RF chain.

The input signal power of the RF chain is reflected in the form of P_{RF,K} or

$${\hat{P}}_{RF , k} = {( {H}_{RF , k} {H}_{RF , k}^{H} )}^{- \frac{H}{2}} {H}_{RF , k} {P}_{RF , k} {{{H}_{RF , k}^{H} ( {H}_{RF , k} {H}_{RF , k}^{H} )}^{-}}^{\frac{1}{2}}$$

in the RF BF design algorithm. \hat{P}_{RF,k} is a function for P_{RF,k}.

Hereinafter, a method of calculating the input signal power P_{RF,K} of the RF chain will be described.

An input of the RF chain according to an embodiment is an output of BB signal processing. In order to reflect the effective input signal power of the RF chain, a whitening process may be performed for F_{BB,k}, and

$${P}_{RF , k} ∈ {ℂ}^{{N}_{RF}^{TX} \times {N}_{RF}^{TX}}$$

may be defined according to the result.

For the whitening process of F_{BB,k}, F_{BB,k} may be decomposed as follows.

$${F}_{BB , k} = {G}_{BB , k} {P}_{BB , k}^{\frac{1}{2}} . \qquad ( 34 )$$

In equation (34) above, G_{BB,k} is a normalized version of F_{BB,k} with each column normalized to 1,

$${P}_{BB , k}^{\frac{1}{2}}$$

is a diagonal matrix, and the iₜₕ diagonal element of the matrix is the Euclidean norm of the iₜₕ column of F_{BB,k}. That is, it may be expressed as follows.

$${G}_{BB , k} ( : , i ) = \frac{{F}_{BBk} ( : , i )}{{‖ {F}_{BBk} ( : , i ) ‖}_{2}} and {P}_{BB , k}^{\frac{1}{2}} ( i , i ) = {‖ {F}_{BB , k} ( : , i ) ‖}_{2} .$$

The whitened F_{BB,k} may be defined as

$${\overline{F}}_{BB , k} = {{G}_{BB , k} ( {G}_{BB , k}^{H} {G}_{BB , k} )}^{- \frac{1}{2}} {P}_{BB , k}^{\frac{1}{2}}$$

and, P_{RF,k} may be defined as the Gramian matrix of F̅_{BB,k} as follows.

$${\overline{F}}_{B B , k} = {{G}_{BB , k} ( {G}_{BB , k}^{H} {G}_{BB , k} )}^{- \frac{1}{2}} {P}_{BB , k}^{\frac{1}{2}} . \qquad ( 35 a )$$

$${P}_{RF , k} = {\overline{F}}_{BB , k} {\overline{F}}_{BB , k}^{H} . \qquad ( 35 b )$$

As an embodiment, the input signal power P_{RF,K} of the RF chain may be calculated by defining

$${P}_{RF , k} = {\overline{F}}_{BB , k} {\overline{F}}_{BB , k}^{H} ,$$

without going through the above-described whitening process. A hybrid beamforming design method according to an embodiment may include the following operations.
1) An operation of designing initial RF BF according to the HBF structure of the base station and users (refer to FIGS. 6 to 9). RF BF designed by a different HBF design method may be configured as the initial RF BF (corresponding to 312 of FIG. 3 and 2310 of FIG. 23).
2) An operation of generating an equivalent baseband channel matrix by multiplying the RF BF and the channel matrix and designing the BB BF using the matrix, after designing the initial RF BF. In this case, the method for designing the BB BF may include BD, RCD, SLNR maximizing, MMSE, and WMMSE BF methods, and the BB BF may also be designed using linear FD BF design methods for MU-MIMO design.
3) An operation of calculating RF chain input signal power (refer to equations (34) and (35)).
4) A performance index (e.g., achievable sum rate) based on the first-designed HBF (a combination of RF BF and BB BF) is calculated (corresponding to 2340 of FIG. 23), and the designed HBF is stored in a storage.
5) The RF BF is designed (or updated) (refer to FIGS. 10 to 13) according to the HBF structure of the base station and users, and the newly designed RF BF is stored in a buffer BF (corresponding to 322 of FIG. 3 and 2410 of FIG. 24).
6) A newly designed RF BF and a channel matrix are multiplied to generate an equivalent baseband channel matrix, the BB BF is designed using the corresponding matrix, and the newly designed BB BF is stored in a buffer (corresponding to 2420 of FIG. 24).
7) A performance index is calculated based on the newly designed HBF (corresponding to 2430 of FIG. 24).
8) If the performance of the newly designed HBF is improved compared to that of the previously designed HBF and the number of design iterations is smaller than a pre-configured maximum number, the index that counts the number of design iterations is increased by one, and the input signal power of the RF chain is calculated (2450 of FIG. 24). If the performance of the newly designed HBF is lower than that of the previously designed HBF or the number of design iterations reaches the maximum number, the design is stopped and communication is performed based on the HBF design results stored in the storage (2460 of FIG. 24).
Step 9: If the input signal power of the RF chain is calculated in step 8, the HBF stored in the buffer is moved to the storage to update the HBF stored in the storage. Steps 4 to 8 are repeatedly performed.

A hybrid beamforming design method according to an embodiment will be described in the case of an HBF base station and an FD BF user (ITS-HBF for the HBF base station and FD BF user).

A hybrid beamforming design method in an OFDM MIMO system, in which both the base station and the user use hybrid beamforming, has been described above. However, in general, a user has a small number of antennas. Therefore, when FD BF is sufficiently available, a beamforming design method may be required for an OFDM MIMO system in which a base station using hybrid beamforming and users using fully-digital beamforming (FD BF) exist.

The hybrid beamforming design method according to an embodiment of the disclosure may be applied to a MU-MIMO OFDM downlink system for the HBF base station and FD BF users.

For example, the part corresponding to the base station's RF BF design in the above-described RF BF design algorithm may be applied, and since the users use FD BF, the RF BF of each user may be represented as an identity matrix. The users' beamformers may not be considered in the initial RF BF design and the update processes.

An update of the RF BF of the base station (in the case where users are FD BF) according to an embodiment of the disclosure is described below.

In case that users use FD BF, W_{RF,u} representing the RF BF of the receivers is mathematically equivalent to the case where all have identity matrices, regardless of the user index u.

Therefore, R^{RF} expressed in equation (31) may be expressed through the following relationship.

$${R}^{RF} {\vert}_{{W}_{{RF}^{= I}}} \leq {ρ}^{′} {log}_{2} \vert {I}_{{\sum }_{u = 1}^{U} {N}_{R F u}^{R X}} + \frac{1}{K {σ}_{n}^{2}} [ {\sum }_{k = 1}^{K} {H}_{k} {F}_{RF} {P}_{RF , k} {F}_{RF}^{H} {H}_{k}^{H} ] \vert = {ρ}^{′} {log}_{2} \vert {I}_{{\sum }_{u = 1}^{U} {N}_{RF , u}^{RX}} + \frac{1}{K {σ}_{n}^{2}} {\sum }_{k = 1}^{K} {H}_{k} {F}_{RF} {{P}_{RF , k} ( {H}_{k} {F}_{RF} )}^{†} {H}_{k} {F}_{RF} {F}_{RF}^{H} {H}_{k}^{H} \vert = {ρ}^{′} {log}_{2} \vert {I}_{{N}_{RF}^{TX}} + \frac{1}{K {σ}_{n}^{2}} {F}_{RF}^{H} [ {\sum }_{k = 1}^{K} {H}_{k}^{H} {H}_{RF , k} {{P}_{RF , k} ( {H}_{RF , k} )}^{†} {H}_{k} ] {F}_{RF} \vert = {ρ}^{′} {log}_{2} \vert {I}_{{N}_{RF}^{TX}} + \frac{1}{K {σ}_{n}^{2}} {F}_{RF}^{H} [ {\sum }_{k = 1}^{K} {H}_{k}^{H} {\hat{P}}_{RF , k} {H}_{k} ] {F}_{RF} \vert {=}^{Δ} {\overline{R}}^{RF} . \qquad ( 36 )$$

In equation (36), H_{RF,k}=HₖF_{RF} and

$${\hat{P}}_{RF , k} = {( {H}_{RF , k} {H}_{RF , k}^{H} )}^{- \frac{H}{2}} {H}_{RF , k} {P}_{RF , k} {{H}_{RF , k}^{H} ( {H}_{RF , k} {H}_{RF , k}^{H} )}^{- \frac{1}{2}} .$$

Therefore, when the base station has a FC-HBF structure, a problem for RF BF design may be expressed as follows.

$${F}_{R F}^{opt} = {arg max {log}_{2}}_{{F}_{RF}} \vert {I}_{{N}_{RF}^{TX}} + \frac{1}{K {σ}_{n}^{2}} {F}_{RF}^{H} [ {\sum }_{k = 1}^{K} {H}_{k}^{H} {\hat{P}}_{RF , k} {H}_{k} ] {F}_{R F} \vert , \qquad ( 37 )$$

$$where \vert {F}_{RF} ( {m}_{TX} , {n}_{RF}^{TX} ) \vert = \frac{1}{\sqrt{{M}_{TX}}} , ∀ ( {m}_{TX} , {n}_{RF}^{TX} ) .$$

When solving the above equation (37), each element may be updated in a direction of maximizing the objective function in order from the first column.

The RF BF design problem of the base station having a PC-HBF structure may be expressed as follows.

$${F}_{R F}^{opt} = arg {max}_{{F}_{R F}} {log}_{2} \vert {I}_{{N}_{R F}^{T X}} + \frac{1}{K {σ}_{n}^{2}} {F}_{R F}^{H} [ {\sum }_{k = 1}^{K} {H}_{k}^{H} {\hat{P}}_{RF , k} {H}_{k} ] {F}_{R F} \vert , \\ where \vert {F}_{R F} ( {m}_{T X} , {n}_{R F}^{T X} ) \vert = \{ \begin{matrix}\sqrt{\frac{{N}_{RF}^{TX}}{{M}_{TX}}} , & if {m}_{TX} ∈ {TX}_{( {n}_{RF}^{TX} )}^{} , \\ 0 , & otherwise\end{matrix} . \qquad ( 38 )$$

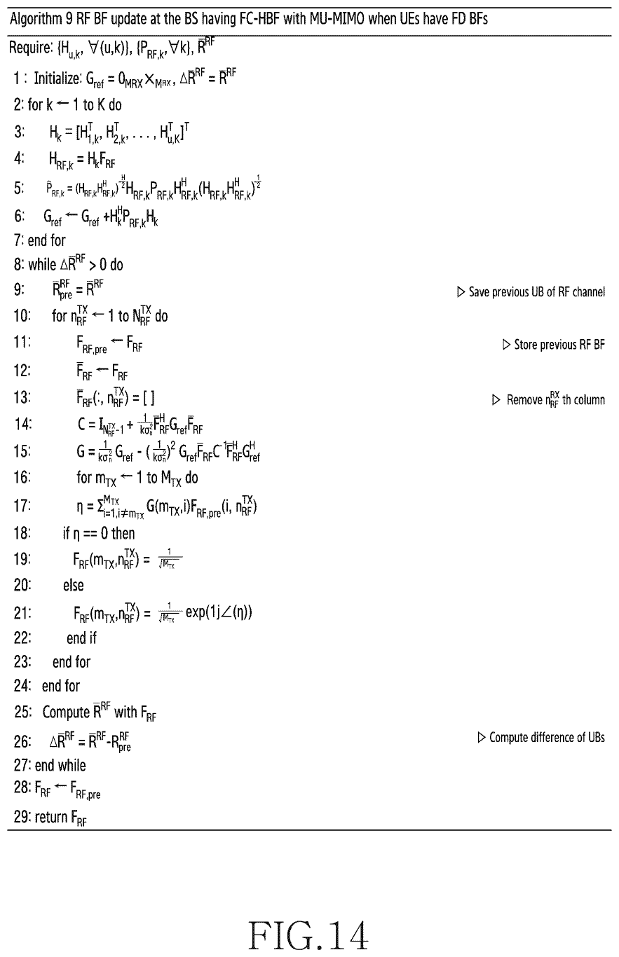

FIG. 14 is a diagram illustrating an example RF BF update algorithm for hybrid beamforming design according to various embodiments. FIG. 14 illustrates an example RF BF design algorithm of the base station having an FC-HBF structure that supports FD BF users. The RF BF of the FC-HBF structure base station may be updated using equation (37). The algorithm of FIG. 14 may correspond to the execution operation of operation 322 of FIG. 3, operation 1822 of FIG. 18, operation 2210 of FIG. 22, or operation 2410 of FIG. 24. In addition, the operation may be performed by the user of FIG. 25 or the base station of FIG. 26.

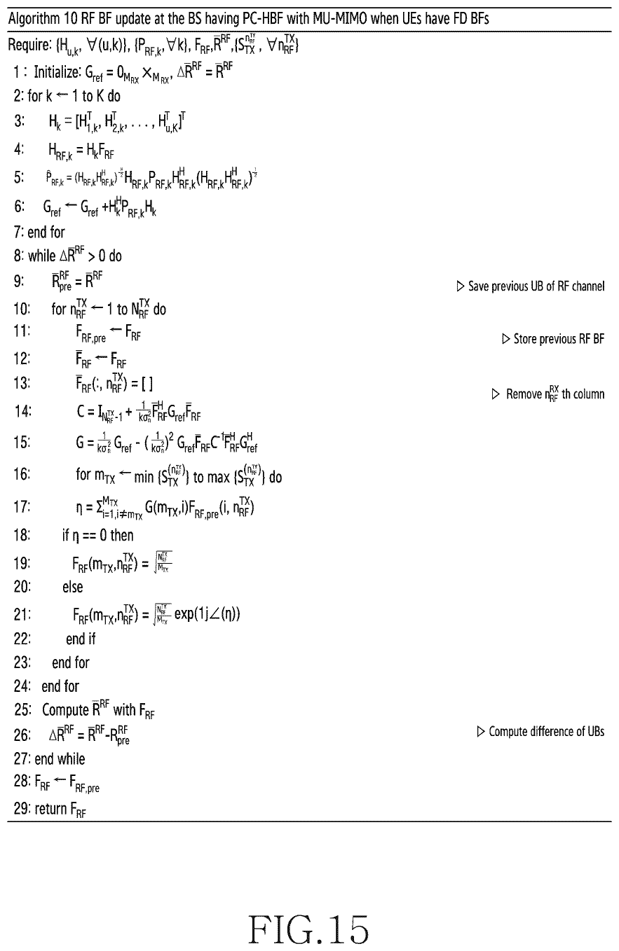

FIG. 15 is a diagram illustrating an example RF BF update algorithm for hybrid beamforming design according to various embodiments. FIG. 15 illustrates an example RF BF design algorithm of the base station having a PC-HBF structure that supports FD BF users. The RF BF of the PC-HBF structure base station may be updated using equation (38). The algorithm of FIG. 15 may correspond to the execution operation of operation 322 of FIG. 3, operation 1822 of FIG. 18, operation 2210 of FIG. 22, or operation 2410 of FIG. 24. In addition, the operation may be performed by the user of FIG. 25 or the base station of FIG. 26.

In addition, since log₂|X| is an increasing function for a positive definite (PD) matrix X, a new upper bound (UB) may be obtained by adding any positive semi-definite (PSD) matrix to the matrix that is the determinant in the logarithm in equations (37) and (38). For example, \hat{P}_{RF,k} may be indirectly changed by substituting P_{RF,K}+Ξₖ, which is the PSD matrix Ξₖ added to \hat{P}_{RF,k}, instead of \hat{P}_{RF,k}, Or \hat{P}_{RF,k} may be directly changed to \hat{P}_{RF,k}+Ξₖ.

In the algorithms of FIGS. 14 and 15, the condition of the while statement (line 8 of FIGS. 14 and 15) may be changed to whether the absolute value of ΔR̅^{RF} exists within a specific range. For example, the conditional statement may be changed to while |ΔR̅^{RF}|>ϵ for any small positive number ϵ. An initial RF BF design method of a base station according to an embodiment of the disclosure (when users are FD BF) will be described.

In the case of FD BF users, the matrix W_{RF,u} indicating the RF BF of the users may be considered as an identity matrix regardless of the user index u.

Therefore, there is no need to alternately perform the initial RF BF design of the base station with the RF BF design of the users. In addition, since the number of RF chains of users in the HBF user environment is equal to the number of data layers, the RF BF design part of the base station is maintained in the initial RF BF design algorithm of FIGS. 6 to 10 and

$${N}_{RF , u}^{R X}$$

is replaced with Lᵤ=max L_{u,k}, and this may be referred to as the first RF BF design algorithm of the base station to support FD BF users.

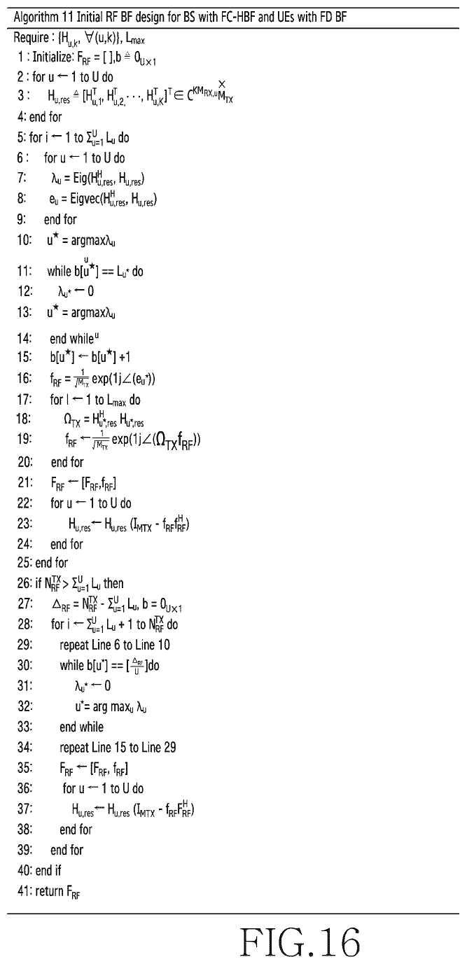

FIG. 16 is a diagram illustrating an example initial RF BF design algorithm for hybrid beamforming design according to various embodiments. FIG. 16 illustrates an example initial RF BF design algorithm of a base station having an FC-HBF structure that supports FD BF users. FIG. 16 may correspond to 312 of FIG. 3, 2210 of FIG. 22, or 2310 of FIG. 23, and the algorithm may be performed by the user of FIG. 25 or the processor of the base station of FIG. 26.

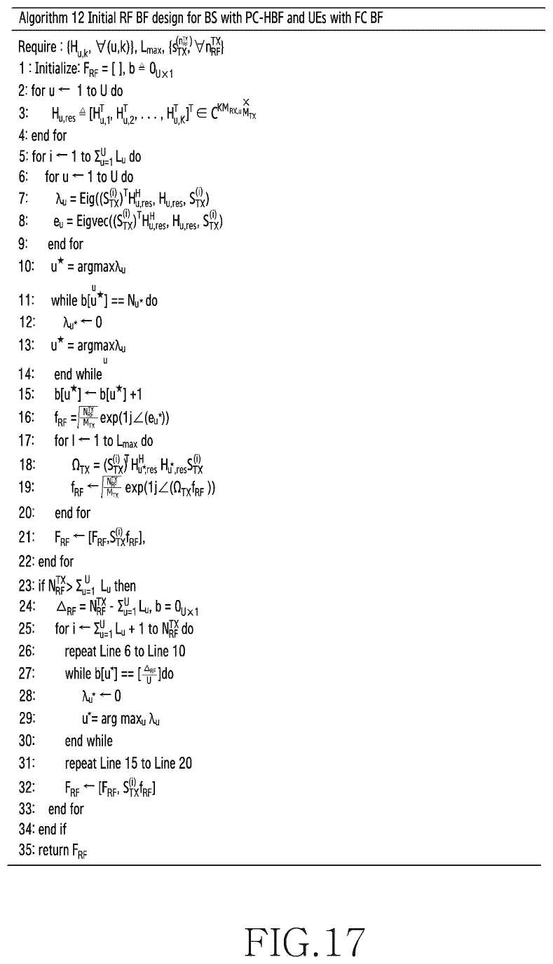

FIG. 17 is a diagram illustrating an example initial RF BF design algorithm for hybrid beamforming design according to various embodiments. FIG. 17 illustrates an example initial RF BF design algorithm of a base station having a PC-HBF structure that supports FD BF users. FIG. 17 illustrates an example initial RF BF design algorithm of a base station having an FC-HBF structure that supports FD BF users. FIG. 17 may correspond to 312 of FIG. 3, 2210 of FIG. 22, or 2310 of FIG. 23, and the algorithm may be performed by the user of FIG. 25 or the processor of the base station of FIG. 26.

A design method of baseband beamforming (BB BF) according to an embodiment of the disclosure is described.

The design of the BB BF according to an embodiment may be designed according to an FD BF design method, considering a channel obtained by multiplying a designed radio channel and RF BFs as an effective channel or an equivalent baseband channel. The input and output relationship using the equivalent baseband channel {H_{eff,u,k}=H_{u,k}F_{RF}, ∀(u,k)} may be expressed as follows.

$${y}_{u , k} = {W}_{B B , u , k}^{H} {H}_{eff , u , k} {F}_{BB , u , k} {s}_{u , k} + {W}_{B B , u , k}^{H} {H}_{eff , u , k} {\sum }_{{u}^{′} \neq u} {F}_{B B , {u}^{′} , k} {s}_{{u}^{′} , k} + {W}_{B B , u , k}^{H} {n}_{u , k} , ∀ ( u , k ) . \qquad ( 39 )$$

The FD BF design method include the following methods, and other methods may also be applied.
1) Block-diagonalization (BD)
2) Regularized BD (RBD) or Regularized channel diagonalization (RCD)
3) SLNR maximizing BF
4) MMSE BF
5) WMMSE BF

An iterative design method (performance index-based) for hybrid beamforming according to an embodiment of the disclosure is described.

In the hybrid beamforming design method according to an embodiment, if a performance index achievable based on the newly designed RF BF and BB BF is not improved over the previously designed result or the maximum number of design iterations has been reached, the design may be stopped and information may be transmitted and received based on the most recently designed result (recently stored result).

If the performance index (e.g., sum rate) is improved based on newly designed RF BF and BB BF, it may be determined that there is room for improvement and the design process may be iterated. When newly designing RF BF, an input power of an RF chain according to a previous BB BF result may be considered.

For example, in the operation of re-designing the RF BF, the BB BF output (or input power of the RF chain) may be considered to reflect the influence of the baseband (BB) BF.

The hybrid beamforming design method according to an embodiment may consider RF chains of the base station and users as virtual antennas, and design RF BF in a direction that maximizes the upper bound (UB) of the total transmission rate by considering the input signal power of the RF chain.

The input signal power of the RF chain is reflected in the form of P_{RF,k} or

$${\hat{P}}_{RF , k} = {( {H}_{RK , k} {H}_{RF , k}^{H} )}^{- \frac{H}{2}} {H}_{RF , k} {P}_{RF , k} {{H}_{RF , k}^{H} ( {H}_{RF , k} {H}_{RF , k}^{H} )}^{- \frac{1}{2}}$$

in the RF BF design algorithm. \hat{P}_{RF,K} is a function for P_{RF,k}.

Hereinafter, a method of calculating the input signal power P_{RF,K} of the RF chain will be described.

An input of the RF chain according to an embodiment is an output of BB signal processing. In order to reflect the effective input signal power of the RF chain, a whitening process may be performed for F_{BB,k}, and

$${P}_{RF , k} ∈ {ℂ}^{{N}_{R F}^{T X} \times {N}_{R F}^{T X}}$$

may be defined according to the result.

For the whitening process of F_{BB,k}, F_{BB,k} may be decomposed as follows.

$${F}_{B B , k} = {G}_{BB , k} {P}_{BB , k}^{\frac{1}{2}} . \qquad ( 40 )$$

In equation (40) above, G_{BB,k} is a normalized version of F_{BB,k} with each column normalized to 1,

$${P}_{BB , k}^{\frac{1}{2}}$$

is a diagonal matrix, and the iₜₕ diagonal element of the matrix is the Euclidean norm of the iₜₕ column of F_{BB,k}. That is, it may be expressed as follows.

$${G}_{B B , k} ( : , i ) = \frac{{F}_{BB , k} ( : , i )}{{‖ {F}_{BB , k} ( : , i ) ‖}_{2}} and {P}_{BB , k}^{\frac{1}{2}} ( i , i ) = {‖ {F}_{BB , k} ( : , i ) ‖}_{2} .$$

The whitened F_{BB,k} may be defined as

$${\overline{F}}_{B B , k} = {{G}_{B B , k} ( {G}_{B B , k}^{H} {G}_{B B , k} )}^{- \frac{1}{2}} {P}_{BB , k}^{\frac{1}{2}}$$

and, P_{RF,k} may be defined as the Gramian matrix of F̅_{BB,k} as follows.

$${\overline{F}}_{B B , k} = {{G}_{B B , k} ( {G}_{B B , k}^{H} {G}_{B B , k} )}^{- \frac{1}{2}} {P}_{BB , k}^{\frac{1}{2}} . \qquad ( 41 a )$$

$${P}_{RF , k} = {\overline{F}}_{B B , k} {\overline{F}}_{B B , k}^{H} . \qquad ( 41 b )$$

Therefore, the matrix P_{RF,K} indicating the input signal power of the RF chain or the output of the BB BF may be calculated. This matrix may be considered in the design of RF BF.

FIG. 18 is a flowchart illustrating an example hybrid beamforming design method according to various embodiments. FIG. 18 may illustrate an example hybrid beamforming design method for supporting FD BF users.

The hybrid beamforming design method illustrated in FIG. 18 may correspond to the design method illustrated in FIG. 3. However, since FIG. 18 illustrates a design method for supporting FD BF users, the matrix W_{RF,u} representing the RF BF of the users is considered to be an identity matrix.

Referring to FIG. 18, the hybrid beamforming design method may include an initial setup operation 1810 and an iterative design operation 1820.

The initial setup operation 1810 includes an operation 1812 of designing initial RF BF (F_{RF}), an operation 1814 of designing BB BF (F_{BB} and W_{BB}), an operation 1816 of calculating input power (P_{RF}) (or input signal power) for an RF chain, and an operation 1818 of calculating a performance index (e.g., sum rate).

The iterative design operation 1820 may include an operation 1822 of designing RF BF, an operation 1824 of designing BB BF, an operation 1826 of calculating a performance index (e.g., sum rate), and an operation 1828 of calculating an input power (P_{RF}) (or input signal power) for the RF chains corresponding to a result of the calculated performance index. 1828 may calculate the input power P_{RF} (or input signal power) for the RF chain when the number of design iterations is less than a maximum number of iterations (j_max) or the calculated performance index is better than a previously calculated performance index (ΔR>0).

The iterative design operation 1820 may iteratively design the RF BF or the BB BF by comparing a calculated performance index with a previously calculated performance index. In addition, the design may be iterated based on a configured maximum number of iterations (j_max) or the design may be terminated when the newly designed HBF no longer increases the performance index (ΔR<0). When the design is terminated, the result of the beamformer design may be determined by the most recently designed and stored value in the storage.

The RF BF design operation 1822 may design the RF BF in a direction of maximizing an upper bound (UB) of an achievable performance index (e.g., sum rate) of an equivalent BB channel by considering an RF chain as a virtual antenna. Unlike conventional design methods, high SNR assumption is not included, and the influence of the BB BF may be considered in the design of the RF BF. The output signal of the BB BF is an input signal from the RF chain's perspective, and thus the output signal power of the BB BF may be considered as an input power matrix when designing RF BF to design the RF BF.

The BB BF design operation 1824 may design the BB BF using the FD BF design solution using an equivalent BB channel.

The hybrid beamforming design method 1800 described in FIG. 18 may represent a design method for a case in which the UE is an FD BF.

1800 may design the BB BF and the RF BF complementarily to each other in consideration of the input signal power of the RF chain. In addition, the design method is also applicable in a case where the number of RF chains of the base station is greater than the total number of RF chains of users and a case where the hybrid beamforming structure of the base station is PC-HBF or FC-HBF. In addition, the design method may also be applied to a system in which frequency resources for SU-MIMO and frequency resources for MU-MIMO coexist, and thus has high applicability, and also exhibits good performance in terms of performance.

Hereinafter, a hybrid beamforming design method in a case where MU-MIMO and SU-MIMO coexist for each frequency resource will be described.

As an embodiment, the frequency resources (subcarriers (SCs), resource elements, or physical resource blocks) allocated to multiple users for information reception may be different from each other, or there may be a case in which a single user uses a specific frequency resource.

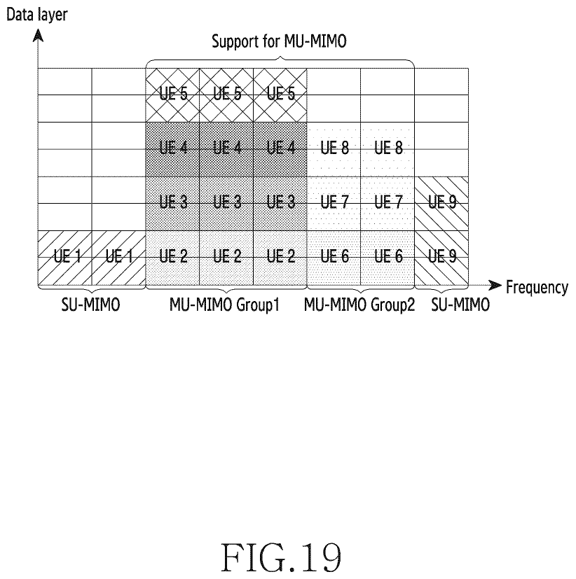

FIG. 19 is a diagram illustrating an example of resource allocation when SU-MIMO and MU-MIMO coexist for each frequency resource according to various embodiments.

Referring to FIG. 19, there may be a case where the total number of users is 9, users 1 and 9 each occupy specific frequency resources, users 2 to 5 become one MU-MIMO group and are allocated the same frequency resources, and the remaining users 6 to 8 become another MU-MIMO group and are allocated the same frequency resources. In this case, if resource allocation is expressed as a grid, it is expressed as in FIG. 19.

In FIG. 19, the y-axis indicates the data layer (or data stream). User 1 is allocated two data layers for each allocated frequency resource, and user 9 is allocated four data layers for each allocated frequency resource.

As illustrated in FIG. 19, in the case where SU-MIMO and MU-MIMO coexist for each frequency resource, hybrid beamforming may be designed by changing the channel information for frequencies for which resources are not allocated to each user (UE) into an all zero matrix. That is, if the user u has not been allocated SC k as a frequency resource for data transmission, H_{u,k}=0 may be considered and the hybrid beamforming design method according to an embodiment may be performed.

If RF BF is given, a matrix obtained by multiplying the RF BF and the channel matrix may be regarded as an equivalent BB channel matrix, and BB BF may be designed. Specifically, in a frequency resource having a single user, BB BF may be designed using an FD BF design method suitable for SU-MIMO, and in frequency resources having multiple users, BB BF may be designed using an FD BF design method suitable for MU-MIMO.

When designing BB BF according to the above-described process, BB BF is not designed for frequency resources that are not allocated to each user, and thus P_{RF,k} may be calculated through equations (34) and (35).

Hereinafter, the performance of the beamforming designed through the hybrid beamforming design method according to an embodiment will be described.

The radio channel between the base station and the user is configured based on the delay-d channel model and the cluster delay line channel model of 3GPP TR 38.901.

It is assumed that the delay-d channel model is generated based on equation (12), the base station and each user have a uniform planar array (ULA) structure in which each antenna element is spaced by half a wavelength, and the time delay caused by each ray within the same cluster is the same. The time delay of each cluster is a random variable that follows a uniform distribution between 0 and the CP length. The average angle of arrival (AoA) and angle of departure (AoD) of each cluster are random variables following a uniform distribution between 0 and 2π. In addition, the spread of the AoA and the AoD is 10°, and the AoA and the AoD are generated according to the Laplacian distribution for each channel generation.

The CDL channel model of 3GPP TR 38.901 is generated based on the CDL-A and CDL-D models according to the CDL delay profile provided by the 5G Toolbox of MATLAB software, and the base station and each user are UPA structures with each antenna element separated by half a wavelength. In a simulation using the CDL channel model, the simulation is performed for a fully-connected (FC) HBF, and the FC-HBF structure has all antenna elements connected to all RF chains and phase shifters. Information on additional parameters in the model is as follows.

$$Maximum Doppler shift = 0 \qquad 1 )$$

$$Center frequency = 6 GHz \qquad 2 )$$

$$Delay spread = 10 ns \qquad 3 )$$

4) AoD, AoA, ZoA and ZoD information are as follows, and Unif indicates uniform distribution.
Mean angle: Unif (0, 360) degrees for AoD and AoA & Unif(0, 180) degrees for ZoA and ZoD

$$Angular spread : \{ \begin{matrix}Unif ( 5 , 25 ) degrees for AoD \\ Unif ( 30 , 60 ) degrees for AoD \\ Unif ( 5 , 15 ) degrees for ZoD \\ Unif ( 1 , 5 ) degrees for ZoD\end{matrix}$$

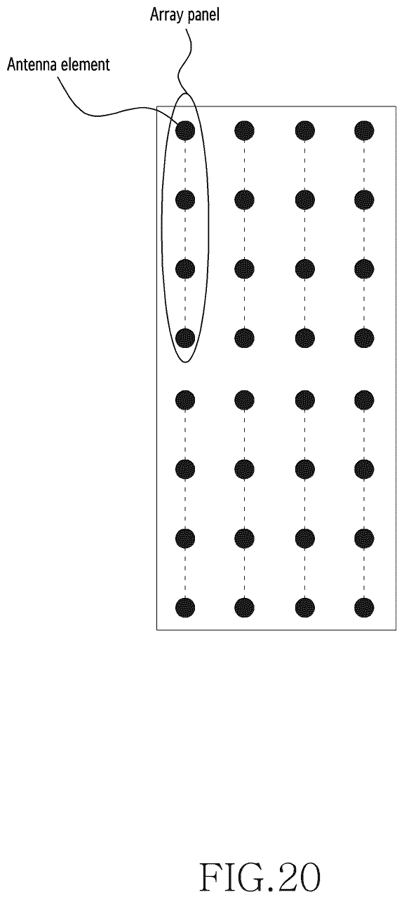

FIG. 20 is a diagram illustrating an example of a base station UPA structure of a CDL channel model according to various embodiments.

Referring to FIG. 20, black dots represent antenna elements, and elements configuring the same array panel are expressed as being connected by dotted lines. The UPA structure of the base station include array panels arranged in two rows and four columns, and each array panel may include four antenna elements in the row direction. The antenna elements may be uni-polarized antenna elements, and the total number of antennas of the antenna array may be 32.

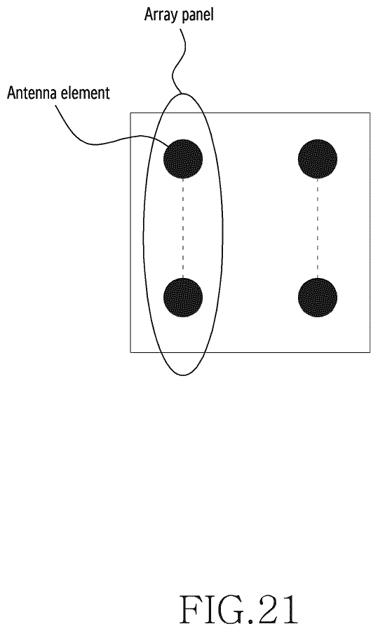

FIG. 21 is a diagram illustrating an example of a user UPA structure of a CDL channel model according to various embodiments.

The UPA structure of each user may include two array panels in the column direction, and each array panel may include two antenna elements in the row direction. The antenna elements may be uni-polarized antenna elements, and the total number of antennas of the antenna array may be 4.

The beamforming for performance simulation is designed according to the above-described embodiment. The number of design iterations is limited to 20. In addition, the calculation equation for P̅_{RF,K} in line 6 of FIGS. 12 and 13 and line 5 of FIGS. 14 and 15 has been applied as

$${\hat{P}}_{RF , k} = {( {H}_{RF , k} {H}_{RF , k}^{H} )}^{- \frac{H}{2}} {H}_{RF , k} {P}_{RF , k} {{H}_{RF , k}^{H} ( {H}_{RF} {H}_{RF , k}^{H} )}^{- \frac{1}{2}} + {σ}_{n}^{2} I .$$

The performance index for performance simulation is the total transmission rate versus SNR, which is calculated as follows. SNR may be defined as the value of the base station's transmission power limit P_{BS} per subcarrier divided by the noise power

$${σ}_{n}^{2}$$

per subcarrier. Therefor, the total transmission rate is defined as follows.

$$R = {\sum }_{u = 1}^{U} {R}_{u} = {ρ}^{′} {\sum }_{u = 1}^{U} \frac{1}{K} {\sum }_{k = 1}^{K} {log}_{2} \vert {I}_{{N}_{RF , u}^{R X}} + {Q}_{u , k}^{- 1} {W}_{u , k}^{H} {H}_{u , k} {F}_{u , k} {F}_{u , k}^{H} {W}_{u , k} \vert .$$

The BF design methods used in the digital BF parts of FD BF and HBF are as follows.
1) Block diagonalization [BD], 2) Regularized channel diagonalization [RCD], 3) SLNR maximizing BF [SLNR], 4) MMSE BF [MMSE], 5) WMMSE BF [WMMSE]

The FD BF and HBF design methods are as follows.
1) Fully digital BF [FD]
2) Constrained tensor decomposition based HBF [Const. TD] (SOTA)
3) Tensor unfolding based HBF [TU] (MU-MIMO OFDM structure-based hybrid beamforming design method disclosed in a conventional paper)

A simulation result of a hybrid beamforming design method according to an embodiment shows that the hybrid beamforming design method outperforms the FD BD, Const. TD, and TU methods. That is, the hybrid beamforming design method according to an embodiment shows superior performance compared to the results of conventional HBF design methods (Const. TD or TU).

The results of multi-angle simulations using various parameters show an efficiency level close to that of the FD BD design method, and at least show superior performance compared to the results obtained by the conventional design method.

The hybrid beamforming design method according to an embodiment may design hybrid beamforming even when the number of RF chains of the base station is greater than the total number of RF chains of users, unlike the conventional technologies of Const. TD and TU.

It has been found that the hybrid beamforming design method according to an embodiment is capable of obtaining additional gain using an extra RF chain in the base station, and is capable of exhibiting performance very close to FD SLNR and FD MMSE performance when an SNR value is high.

The hybrid beamforming design method according to an embodiment may be applied to various PSN structures (or HBF structures) of the base station and users.

The hybrid beamforming design method according to an embodiment may outperform FD BF in the FC/FC environment when the SNR is high, and may also be sufficiently close to the FD BF performance in the FC/PC environment. That is, the hybrid beamforming design method according to an embodiment has a great effect in that a performance equal to or higher than that of FD may be obtained using a smaller number of RF chains than the number of required RF chains for FD.

In the case of the CDL channel, it has also been identified that the hybrid beamforming design method according to an embodiment has superior performance to that of the SOTA technique, and shows performance close to that of the FD BF.

Hybrid beamforming according to an embodiment shows a result almost identical to that in the case of an FD BF base station.

The hybrid beamforming design method according to an embodiment may be applied to both PC-HBF and FC-HBF, and also has an effect of enabling BF design for UEs using FD BF.

FIGS. 22, 23, and 24 are flowcharts illustrating example hybrid beamforming design methods according to various embodiments.

Referring to FIG. 22, the hybrid beamforming design method according to an embodiment of the disclosure may include an operation 2210 of designing a radio frequency beamforming (RF BF), an operation 2220 of designing a baseband beamforming (BB BF), and an operation 2230 of calculating a performance index.

The operation 2210 of designing a radio frequency beamforming may correspond to the operation 312 of designing initial radio frequency beamforming or the operation 322 of designing a radio frequency beamforming based on the input power of the RF chain in FIG. 3. In addition, the operation 2210 of designing a radio frequency beamforming may correspond to the operation 1812 of designing initial radio frequency beamforming or the operation 1822 of designing a radio frequency beamforming based on the input power of the RF chain in FIG. 18.

The operation 2220 of designing a baseband beamforming may correspond to the operation 314 or 324 of designing BB BF in FIG. 3. In addition, the operation 2220 of designing a baseband beamforming may correspond to the operation 1814 or 1824 of designing BB BF in FIG. 18.

The operation 2230 of calculating a performance index may correspond to the operation 318 or 326 of calculating a sum rate in FIG. 3. In addition, in FIG. 3, the operation 2230 of calculating a performance index may correspond to the operation 1818 or 1826 of calculating a sum rate in FIG. 18.

FIG. 23 and FIG. 24 are flowcharts illustrating an example hybrid beamforming design method according to various embodiments.

Referring to FIG. 23, the hybrid beamforming design method according to an embodiment of the disclosure may include an operation 2310 of designing first radio frequency beamforming, an operation 2320 of designing first baseband beamforming, an operation 2340 of calculating a first performance index, and an operation 2330 of calculating a first matrix regarding the input strength of the first radio frequency beamforming.

The operation 2310 of designing first radio frequency beamforming may correspond to the operation 312 in FIG. 3, and the operation 2320 of designing first baseband beamforming may correspond to the operation 314 in FIG. 3. In addition, the operation 2340 of calculating a first performance index may correspond to the operation 318 in FIG. 3, and the operation 2330 of calculating a first matrix regarding the input strength of the first radio frequency beamforming may correspond to the operation 316 in FIG. 3.

Operation 2310 of designing first radio frequency beamforming may correspond to the operation 1812 in FIG. 18, and the operation 2320 of designing first baseband beamforming may correspond to the operation 1814 in FIG. 18. Operation 2340 of calculating a first performance index may correspond to the operation 1818 in FIG. 18, and the operation 2330 of calculating a first matrix regarding the input strength of the first radio frequency beamforming may correspond to the operation 1816 in FIG. 18.

Operation 2310 of designing first radio frequency beamforming indicates an operation of designing initial (first) RF BF. As shown in FIGS. 6 to 9, the initial RF BF may be designed based on the phase shift network structure of the base station and the user.

Therefore, Operation 2310 of designing the first radio frequency beamforming may include forming a number of radio frequency (RF) beam pairs corresponding to the total number of RF chains of the users for the RF chains of the base station and the RF chains of the users, and in case that the RF chain of the base station remains, assuming that the users have an additional RF chain of an FC-PSN structure and designing the RF beamforming. In other words, in operation 2310, when the number of RF chains of the base station is greater than the number of RF chains of users, the users may be considered to have additional RF chains and the radio frequency beamforming may be designed.

Operation 2320 of designing first baseband beamforming may design a baseband beamforming (BB BF) based on the designed first radio frequency beamforming. An operation of designing the BB BF may consider a channel obtained by multiplying a designed radio channel and RF BFs as an effective channel or an equivalent baseband channel, and design the BB BF according to a FD BF design method. The FD BF design method may include 1) block-diagonalization (BD), 2) regularized BD (RBD) or regularized channel diagonalization (RCD), 3) SLNR maximizing BF, 4) MMSE BF, or 5) WMMSE BF methods, and may also include another FD BF design method not listed above.

Operation 2340 of calculating a first performance index may calculate a first performance index (R1) based on the designed first radio frequency beamforming and first baseband beamforming. In this case, the performance index may include various indices indicating the performance of beamforming, such as a sum rate and a total transmission rate versus an SNR.

In operation 2330 of calculating the first matrix regarding the input strength of the first radio frequency beamforming, the first matrix is a matrix indicating the input signal power of the RF chain. In addition, the first matrix is a matrix indicating the output signal power of the designed BB BF. That is, the first matrix refers to a matrix that represents the input signal power of the RF BF or the output signal power of the BB BF. In an algorithm according to an embodiment, the P_{RF,k} or \hat{P}_{RF,k} term may correspond to the first matrix, and the method for calculating the P_{RF,k} or \hat{P}_{RF,k} term has been described above in the description of equations (35a) and (35b).

FIG. 24 is a flowchart illustrating an example design process associated with operation 2330 in FIG. 23.

Referring to FIG. 24, the hybrid beamforming design method according to an embodiment may further include an operation 2410 of designing second radio frequency beamforming based on a first matrix, an operation 2420 of designing second baseband beamforming, an operation 2430 of calculating a second performance index, an operation 2440 of comparing performance indices, and/or an operation 2450 of calculating a second matrix regarding the input strength of the second radio frequency beamforming.

Operation 2410 of designing the second radio frequency beamforming may correspond to 322 in FIG. 3 or 1822 in FIG. 18. Therefore, the second radio frequency beamforming may be designed based on the first matrix calculated in a previous process. The first matrix is related to the input signal power of the RF BF or the output signal power of the BB BF.

2410 may design the second radio frequency beamforming based on the first matrix with regard to various phase shift network structures like the algorithm illustrated in FIG. 10 to FIG. 13, and the second radio frequency beamforming may be designed in a direction to maximize the total transmission rate upper bound.

The step 2430 of calculating the second performance index calculates a performance index (R2) based on the newly designed second radio frequency beamforming and second baseband beamforming. Here, the performance index may include various indices indicating beamforming performance such as a sum rate or total transmission rate.

Operation 2440 may represent an operation of determining whether to repeat the design. 2440 may compare the second performance index (R2) with the first performance index (R1) or compare the current number of design iterations with the maximum number of design iterations.

The second performance index is a performance index calculated based on beamforming recently designed, and the first performance index is a performance index calculated based on beamforming designed earlier. If the second performance index is better than the first performance index (for example, R2>R1), it is determined that there is a possibility that the efficiency may be improved by the iterative design. If the performance index is a transmission rate, in case that the second transmission rate is greater than the first transmission rate, operation 2450 may be performed to perform an iterative design process. In addition, if the current number of design iterations is smaller than a preconfigured maximum number of design iterations, operation 2450 may be performed so that the iterated design process is performed.

In case that the second performance index (R2) is superior to the first performance index (R1) and the current number of design iterations is smaller than the preconfigured maximum number of design iterations, operation 2450 may be performed and the beamforming design may be iterated. That is, operation 2450 may be performed corresponding to the second performance index.

Operation 2450 calculates a second matrix regarding the input strength of the second radio frequency beamforming which is most recently designed. The second matrix may represent a matrix related to the input strength of the second radio frequency beamforming or the output strength of the second baseband beamforming. The method of calculating the second matrix has been described above in the description of equations (35a), (35b) or equations (41a), (41b).

Thereafter, the design process of the hybrid beamforming may include designing third radio frequency beamforming based on the second matrix, designing third baseband beamforming, calculating a third performance index, and determining whether to perform iterative design based on the third performance index. If such a design is iterated, Nin radio frequency beamforming, Nₜₕ baseband beamforming, and Nₜₕ performance index may be calculated based on the number of design iterations.

If the performance index is no longer improved or the number of design iterations reaches the maximum number of prespecified iterative design, the latest beamforming design result is applied (2460).

FIG. 25 is a block diagram illustrating an example configuration of a user equipment according to various embodiments.

Referring to FIG. 25, the user equipment (UE) 2500 may include a transceiver 2510, a memory 2520, and a processor (e.g., including processing circuitry) 2530.

The transceiver 2510, the memory 2520, and the processor 2530 of the UE may operate according to the above-described communication methods of the UE. However, components of the UE are not limited thereto. For example, the UE may include a larger or smaller number of components than the above-described components. The processor 2530, the transceiver 2510, and the memory 2520, may be implemented as a single chip. The processor 2530 may include at least one processor. The UE in FIG. 25 may perform the hybrid beamforming design method described in FIGS. 1 to 24.

The transceiver 2510 may refer, for example, to a UE receiver and a UE transmitter as a whole, and may transmit/receive signals with base stations or network entities. The signals transmitted/received with base stations or network entities may include control information and data. The transceiver 2510 may include an RF transmitter for up-converting and amplifying the frequency of a transmitted signal and an RF receiver for low-noise amplifying and down-converting the frequency of a received signal. However, this is only an example of the transceiver 2510, and the components of the transceiver 2510 are not limited to the RF transmitter and the RF receiver.

The transceiver 2510 may receive signals through a radio channel, output the same to the processor 2530, and transmit signals, output from the processor 2530, through the radio channel.

The memory 2520 may store programs and data necessary for the operation of the UE. In addition, the storage 2520 may store control information or data included in signals acquired by the UE. The memory 2520 may be storage media, such as a read-only memory (ROM), a random access memory (RAM), a hard disk, a CD-ROM, and a DVD, or a combination of storage media.

The processor 2530 may include various processing circuitry and control a series of processes to operate the UE as described above. For example, the transceiver 2510 may receive data signals including control signals, transmitted by base stations or network entities, and the processor 2530 may determined results of receiving the control signals and the data signals transmitted by the base stations or network entities.

The processor 2530 of the UE may perform the operations for hybrid beamforming design described in FIGS. 3, 18, and 22 to 24, and the transceiver 2510 may transmit/receive information for performing hybrid beamforming design. In addition, the memory 2520 may store algorithms and the like for hybrid beamforming design. Further, the processor 2530 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

FIG. 26 is a block diagram illustrating an example configuration of a base station according to various embodiments.

Referring to FIG. 26, the base station 2600 may include a transceiver 2610, a memory 2620, and a processor (e.g., including processing circuitry) 2630.

The transceiver 2610, the memory 2620, and the processor 2630 of the base station may operate according to the above-described communication methods of the base station. However, components of the base station are not limited thereto. For example, the base station may include a larger or smaller number of components than the above-described components. The processor 2630, the transceiver 2610, and the memory 2620, may be implemented as a single chip. The processor 2630 may include one or more processors. The base station in FIG. 26 may perform the hybrid beamforming design method described in FIGS. 1 to 24.

The transceiver 2610 may refer, for example, to a base station receiver and a base station transmitter as a whole, and may transmit/receive signals with UEs or network devices. The signals transmitted/received with UEs or network entities may include control information and data. The transceiver 2610 may include an RF transmitter for up-converting and amplifying the frequency of a transmitted signal and an RF receiver for low-noise amplifying and down-converting the frequency of a received signal. However, this is only an embodiment of the transceiver 2610, and the components of the transceiver 2610 are not limited to the RF transmitter and the RF receiver.

The transceiver 2610 may receive signals through a radio channel, output the same to the processor 2630, and transmit signals, output from the processor 2630, through the radio channel.

The memory 2620 may store programs and data necessary for the operation of the base station. In addition, the memory 2620 may store control information or data included in signals acquired by the base station. The memory 2620 may be storage media, such as a read-only memory (ROM), a random access memory (RAM), a hard disk, a CD-ROM, and a DVD, or a combination of storage media.

The processor 2630 may include various processing circuitry and control a series of processes to operate the base station as described above. For example, the transceiver 2610 may receive data signals including control signals, transmitted by UEs, and the processor 2630 may determined results of receiving the control signals and the data signals transmitted by the UEs.

The processor 2630 of the base station may perform the operations for hybrid beamforming design described in FIGS. 3, 18, and 22 to 24, and the transceiver 2610 may transmit/receive information for performing hybrid beamforming design. In addition, the memory 2620 may store algorithms and the like for hybrid beamforming design. Further, the processor 2630 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

A hybrid beamforming design method according to an example embodiment of the disclosure includes designing first radio frequency beamforming (RF BF), designing first baseband beamforming (BB BF) based on the first radio frequency beamforming, and calculating a first matrix related to an input of the first radio frequency beamforming.

In an example embodiment, designing the first radio frequency beamforming may form the same number of RF beam pairs as the number of RF chains of users with respect to the RF chains of a base station and the RF chains of the users.

In an example embodiment, designing the first radio frequency beamforming may design the first RF beamforming by assuming that the users have additional RF chains when the number of RF chains of the base station is greater than the number of RF chains of the users.

The design method may further include designing second radio frequency beamforming based on the first matrix and designing second baseband beamforming based on the second radio frequency beamforming.

In an example embodiment, the design method may further include calculating a first performance index based on the first radio frequency beamforming and the first baseband beamforming, calculating a second performance index based on the second radio frequency beamforming and the second baseband beamforming, calculating a second matrix regarding an input of the second radio frequency beamforming in correspondence with the second performance index, and designing third radio frequency beamforming and third baseband beamforming, based on the second matrix.

In an example embodiment, the first performance index indicates a first transmission rate, the second performance index indicates a second transmission rate, and calculating the second matrix may be performed when the second transmission rate is greater than the first transmission rate.

In an example embodiment, calculating the second matrix may be performed based on a prespecified maximum number of design iterations.

In an example embodiment, a design may be performed using a channel matrix (H), for which a resource is not allocated to a user, as a zero matrix when a single user is allocated to a first frequency resource and multiple users are allocated to a second frequency resource.

In an example embodiment, a base station includes one of a fully-connected phase shift network structure and a partially-connected phase shift network structure and a user includes one of a fully-connected phase shift network structure and a partially-connected phase shift network structure or a fully-digital beamforming structure.

A hybrid beamforming design device according to an example embodiment includes a transceiver and at least one processor, comprising processing circuitry, connected to the transceiver, and at least one processor, individually and/or collectively, may be configured to perform designing first radio frequency beamforming (RF BF), designing first baseband beamforming (BB BF) based on the first radio frequency beamforming, and calculating a first matrix related to an input of the first radio frequency beamforming.

In an example embodiment, designing the first radio frequency beamforming may form the same number of RF beam pairs as the number of RF chains of users with respect to the RF chains of a base station and the RF chains of the users.

In an example embodiment, designing the first radio frequency beamforming may design the first RF beamforming by assuming that the users have additional RF chains when the number of RF chains of the base station is greater than the number of RF chains of the users.

In an example embodiment, the processor may further perform designing second radio frequency beamforming based on the first matrix and designing second baseband beamforming based on the second radio frequency beamforming.

In an example embodiment, the processor may further perform calculating a first performance index based on the first radio frequency beamforming and the first baseband beamforming, calculating a second performance index based on the second radio frequency beamforming and the second baseband beamforming, calculating a second matrix regarding an input of the second radio frequency beamforming in correspondence with the second performance index, and designing third radio frequency beamforming and third baseband beamforming, based on the second matrix.

In an example embodiment, the first performance index indicates a first transmission rate, the second performance index indicates a second transmission rate, and the processor performs calculating the second matrix when the second transmission rate is greater than the first transmission rate.

In an example embodiment, calculating the second matrix may be performed based on a prespecified maximum number of design iterations.

In an example embodiment, the processor may perform a design using a channel matrix (H), for which a resource is not allocated to a user, as a zero matrix when a single user is allocated to a first frequency resource and multiple users are allocated to a second frequency resource.

In an example embodiment, a base station includes one of a fully-connected phase shift network structure and a partially-connected phase shift network structure and a user includes one of a fully-connected phase shift network structure and a partially-connected phase shift network structure or a fully-digital beamforming structure.

A hybrid beamforming design method and device according to an embodiment of the disclosure may provide an excellent data transfer rate effect in a hybrid beamforming structure that is spatially more efficient than a fully digital (FD) beamforming structure.

For example, an embodiment may achieve an excellent data transfer rate by optimizing performance through an iterative design method considering the output of the BB BF or the input of the RF BF.

An embodiment has the advantage of high versatility as it may be applied regardless of the phase shift network structure of the base station or the user, and may be applied even when the user is FD BF

An embodiment is a method that may be applied even when the number of RF chains of the base station is greater than the total number of the RF chains of users, and may be easily applied even in an environment where SU-MIMO and MU-MIMO coexist, thereby further increasing versatility.

It should be appreciated that the various example embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used in various embodiments of the disclosure, the term “module” may include a unit implemented in hardware, software, or firmware, or any combination thereof, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Herein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a purchaser. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

What is claimed is:

1. A hybrid beamforming design method comprising:
designing first radio frequency beamforming (RF BF);
designing first baseband beamforming (BB BF), based on the first radio frequency beamforming; and
calculating a first matrix associated with an input of the first radio frequency beamforming.

2. The method of claim 1, wherein the designing of the first radio frequency beamforming comprises, for RF chains of a base station and RF chains of users, forming a same number of RF beam pairs as the number of the RF chains of the users.

3. The method of claim 2, wherein the designing of the first radio frequency beamforming comprises:
based on the number of the RF chains of the base station being greater than the number of the RF chains of the users, designing the first RF beamforming, assuming that the users have additional RF chains; and
based on the number of the RF chains of the base station being less than the number of the RF chains of the users, designing the first RF beamforming, assuming that the base station has additional RF chains.

4. The method of claim 1, further comprising:
designing second radio frequency beamforming, based on the first matrix; and
designing second baseband beamforming, based on the second radio frequency beamforming.

5. The method of claim 4, further comprising:
calculating a first performance index, based on the first radio frequency beamforming and the first baseband beamforming;
calculating a second performance index, based on the second radio frequency beamforming and the second baseband beamforming;
calculating a second matrix associated with an input of the second radio frequency beamforming according to the second performance index; and
designing third radio frequency beamforming and third baseband beamforming, based on the second matrix.

6. The method of claim 5, wherein the first performance index indicates a first transmission rate,
wherein the second performance index indicates a second transmission rate, and
wherein the calculating of the second matrix is performed based on the second transmission rate being greater than the first transmission rate.

7. The method of claim 6, wherein the calculating of the second matrix is performed based on a specified maximum number of iterations of design.

8. The method of claim 4, further comprising, based on a single user being assigned a first frequency resource and multiple users are assigned a second frequency resource, performing a design by setting a channel matrix (H), in which no resources are assigned to users, as a zero matrix.

9. The method of claim 4, wherein a base station includes one of a fully-connected phase shift network structure and a partially-connected phase shift network structure, and
wherein a user includes one of a fully-connected phase shift network structure and a partially-connected phase shift network structure, or has a fully-digital beamforming structure.

10. A hybrid beamforming design device comprising:
a transceiver;
a processor; and
a memory storing instructions that, when executed by the processor, cause the device to:
design first radio frequency beamforming (RF BF);
design first baseband beamforming (BB BF), based on the first radio frequency beamforming; and
calculate a first matrix associated with an input of the first radio frequency beamforming.

11. The device of claim 10, wherein the memory further comprises instructions that, when executed by the processor, cause the device to, for RF chains of a base station and RF chains of users, form a same number of RF beam pairs as the number of the RF chains of the users.

12. The device of claim 11, wherein the memory further comprises instructions that, when executed by the processor, cause the device to:
based on the number of the RF chains of the base station being greater than the number of the RF chains of the users, design the first RF beamforming, assuming that the users have additional RF chains; and
based on the number of the RF chains of the base station being less than the number of the RF chains of the users, design the first RF beamforming, assuming that the base station has additional RF chains.

13. The device of claim 10, wherein the memory further comprises instructions that, when executed by the processor, cause the device to:
design second radio frequency beamforming, based on the first matrix, and
design second baseband beamforming, based on the second radio frequency beamforming.

14. The device of claim 13, wherein the memory further comprises instructions that, when executed by the processor, cause the device to:
calculate a first performance index, based on the first radio frequency beamforming and the first baseband beamforming,
calculate a second performance index, based on the second radio frequency beamforming and the second baseband beamforming,
calculate a second matrix associated with an input of the second radio frequency beamforming according to the second performance index, and
design third radio frequency beamforming and third baseband beamforming, based on the second matrix.

15. The device of claim 14, wherein the first performance index indicates a first transmission rate,
wherein the second performance index indicates a second transmission rate,
wherein the memory further comprises instructions that, when executed by the processor, cause the device to calculate the second matrix based on the second transmission rate being greater than the first transmission rate.

16. The device of claim 15, wherein the second matrix is calculated based on a specified maximum number of iterations of design.

17. The device of claim 13, wherein the memory further comprises instructions that, when executed by the processor, cause the device to:
based on a single user is assigned a first frequency resource and multiple users are assigned a second frequency resource, perform a design by setting a channel matrix (H), in which no resources are assigned to users, as a zero matrix.

18. The device of claim 13, wherein a base station includes one of a fully-connected phase shift network structure and a partially-connected phase shift network structure, and
wherein a user includes one of a fully-connected phase shift network structure and a partially-connected phase shift network structure, or has a fully-digital beamforming structure.

19. One or more non-transitory computer-readable storage media storing one or more computer programs including computer-executable instructions that, when executed by one or more processors of a device individually or collectively, cause the device to perform operations, the operations comprising:
designing first radio frequency beamforming (RF BF);
designing first baseband beamforming (BB BF), based on the first radio frequency beamforming; and
calculating a first matrix associated with an input of the first radio frequency beamforming.

20. The one or more non-transitory computer-readable storage media of claim 19, wherein the designing of the first radio frequency beamforming comprises, for RF chains of a base station and RF chains of users, forming a same number of RF beam pairs as the number of the RF chains of the users.
